(19) United States
(12) Patent Application Publication
(10) Pub. No.: US 2025/0365467 A1
(43) Pub. Date: Nov. 27, 2025

(54) INTERACTIVE CONTENT CARDS FOR VIDEO

(71) Applicant: Microsoft Technology Licensing, LLC, Redmond, WA (US)

(72) Inventors: Chaitanya GUPTA, Haryana (IN); Lakshay TUTLANI, Delhi (IN); Mahima SEHGAL, Haryana (IN); Jenil Nilangbhai KHANDHARA, Gujarat (IN); Samik PRAKASH, Haryana (IN); Ashish RAJVANSHI, Uttar Pradesh (IN); Ankita Christine XESS, New Delhi (IN); Punit CHHAJER, Uttar Pradesh (IN); Radhika AGRAWAL, Uttar Pradesh (IN); Navneet KAUR, Uttar Pradesh (IN)

(21) Appl. No.: 18/939,909

(22) Filed: Nov. 7, 2024

(30) Foreign Application Priority Data
May 23, 2024 (IN) 202411040276

(51) Int. Cl. H04N 21/431; G06F 40/166; G06F 40/40; H04N 21/44

(52) U.S. Cl. CPC H04N 21/4316; G06F 40/166; G06F 40/40; H04N 21/44008

(57) ABSTRACT

Technology is disclosed for programmatically generating interactive content cards (ICCs) for enhancing digital video content. In one implementation, an ICC overlays video content without altering the underlying video, providing viewers with additional, contextually relevant information as the video is viewed. The ICCs may be dynamically presented based on predefined presentation criteria, such as temporal markers, detected events, or recognized objects within the video that correspond to the information in the cards. Upon detecting a viewer's interaction with an ICC, a content window providing supplemental information about the video is presented. The supplemental information is generated using a query to a knowledge base, which may include a search engine or a language model, ensuring that the information is current and relevant.

### BACKGROUND

The proliferation of digital video content across various platforms has revolutionized the way people consume media. Video clips, live streams, user-generated “stories,” and vlogs have become a staple in the digital landscape, offering a dynamic and engaging way for creators to share their experiences, knowledge, and creativity. However, the richness of video content often hinges on the viewer's ability to fully understand and appreciate the context within which it is presented.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present disclosure are directed towards technologies for enhancing a viewer's experience of digital video content through the use of interactive content cards (ICCs). In particular, embodiments described herein provide functionality enabling video viewers or a video creator to provide context to content in a video via ICCs. The content cards, which are user interface elements, are configured to overlay video content without altering the underlying video content, thereby enabling viewers to receive additional, contextually relevant information as a video is viewed. The video may be a video file or prerecorded video media, a live video feed, or streaming video media, and the content card presented in conjunction with the video may correspond to an entity or subject in the video, such as an object, person, event, or location, and may present a name or an image for the entity or subject.

In various implementations, content cards are presented in a minimized size format in order to minimize obstruction of an underlying video, but still signal to a viewer that supplemental information, such as context regarding the video, is available. For instance, one example of a content card presented in a minimized size format depicts a name or image regarding the entity to which it corresponds in the video, such as shown in regards to the example ICC 347 of FIG. 3F. Upon an interaction with the content card by the viewer, such as by clicking on or touching the content card, the supplemental information is presented. For example, the content card expands to present a supplemental content window of supplemental information or another user interface element, which includes a supplemental content window with the supplemental information, is presented over or adjacent to the video. In this way, the supplemental content window provides further details about an entity or subject referenced on the content card, where a viewer has requested further details by interacting with the content card, thereby enhancing the viewer's understanding and engagement with the video content. The interactive content cards may be dynamically presented based on predefined presentation criteria, such as temporal markers, detected events, or recognized objects within the video that correspond to the information in the cards.

In various embodiments, the supplemental information is generated using a query to a knowledge base, which may include a search engine or language model. Moreover, the supplemental information may be determined at the time a viewer engages with the card via an interaction, rather than determined at an earlier time when the content card is created. Accordingly, the data used for presenting a content card, referred to herein as content card data, is small. In particular, some embodiments of content card data for a particular content card include an indication of the entity and a presentation criterion specifying a condition under which the content card is presented. Advantageously, this light data footprint enables content card data to be stored in a video header or in metadata associated with the video, in some embodiments. Additionally, the creation of a content card is simplified because the card creator is not required to author the supplemental information. Further still, the supplemental information is more likely to be current, rather than out-of-date, because it is determined at the time of the interaction by a viewer.

In this way, embodiments described herein improve the functionality of video content generated or presented by computing applications accessible on user computing devices. In particular, the disclosed technology provides a solution to the limitations of static, non-interactive information traditionally added to videos. By offering real-time, interactive, and contextually relevant information through content cards, the present disclosure aims to enrich the viewer's experience, cater to individual knowledge and interest levels, and foster a more engaging and informative digital video landscape.

### BRIEF DESCRIPTION OF THE DRAWINGS

Aspects of the disclosure are described in detail below with reference to the attached drawing figures, wherein:

FIG. 1 is a block diagram of an example operating environment suitable for implementations of the present disclosure;

FIG. 2 is a diagram depicting an example computing architecture suitable for implementing aspects of the present disclosure;

FIGS. 3A-3N illustratively depict schematic screenshots from a computing device showing various aspects of graphical user interfaces regarding the creation or presentation of interactive content cards, in accordance with embodiments of the present disclosure;

FIG. 4 depicts a flow diagram of a method for presenting and operating an interactive content card, in accordance with an embodiment of the present disclosure;

FIG. 5 depicts a flow diagram of a method for programmatically generating an interactive content card, in accordance with an embodiment of the present disclosure;

FIG. 6 is a block diagram of an example computing environment suitable for use in implementing an embodiment of the present disclosure; and

FIG. 7 is a block diagram of an example computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

Embodiments of this disclosure provide technologies to programmatically generate contextually relevant information or other supplemental information during viewing of a video via ICCs, thereby enhancing a viewer's experience of digital video content. An ICC comprises a graphical user interface element that overlays video content and provides additional, contextually relevant information without altering the underlying video. An ICC may be created by the video creator or by a subsequent viewer of the video. The video may be a video file or prerecorded video media, a live video feed, or streaming video media. The ICC presented in conjunction with the video may correspond to an entity or subject in the video, such as an object, person, event, or location, and may present a name or an image for the entity or subject.

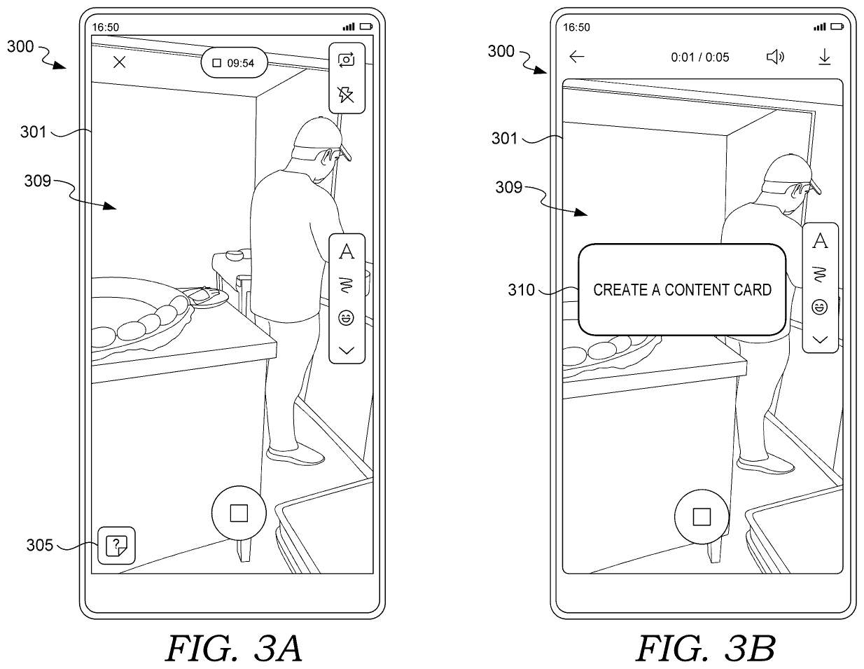

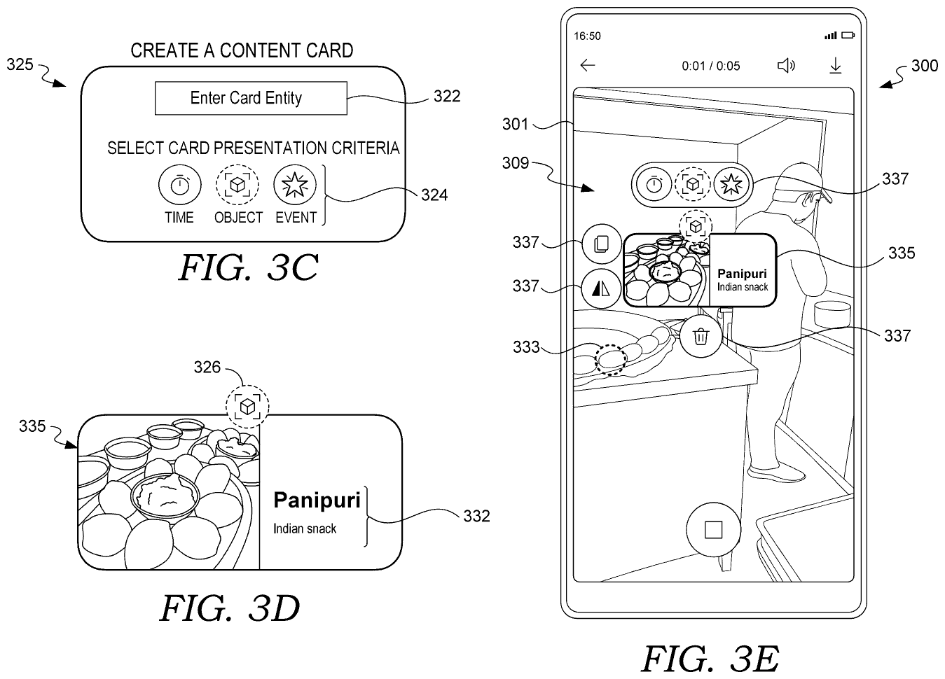

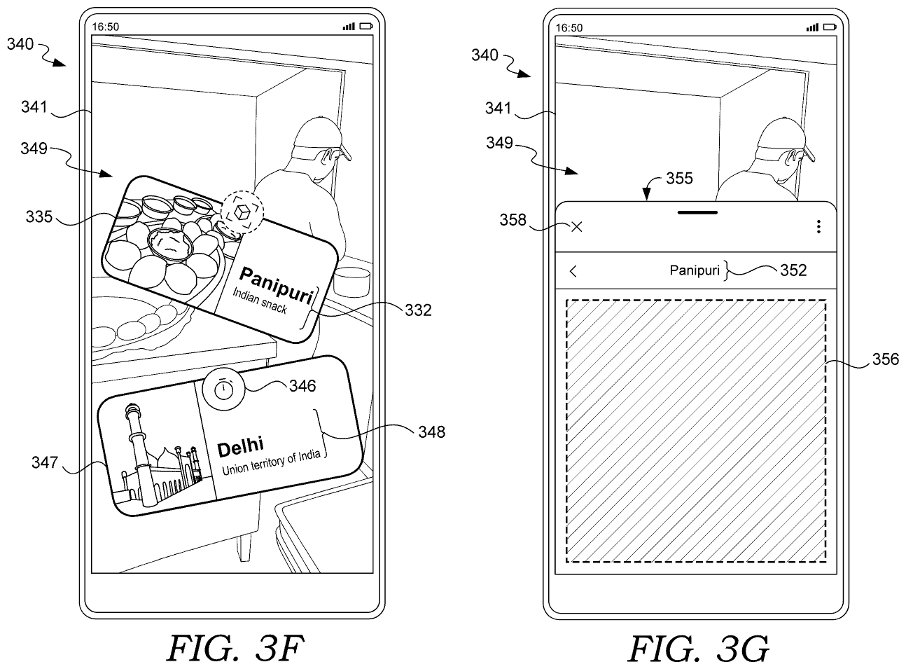

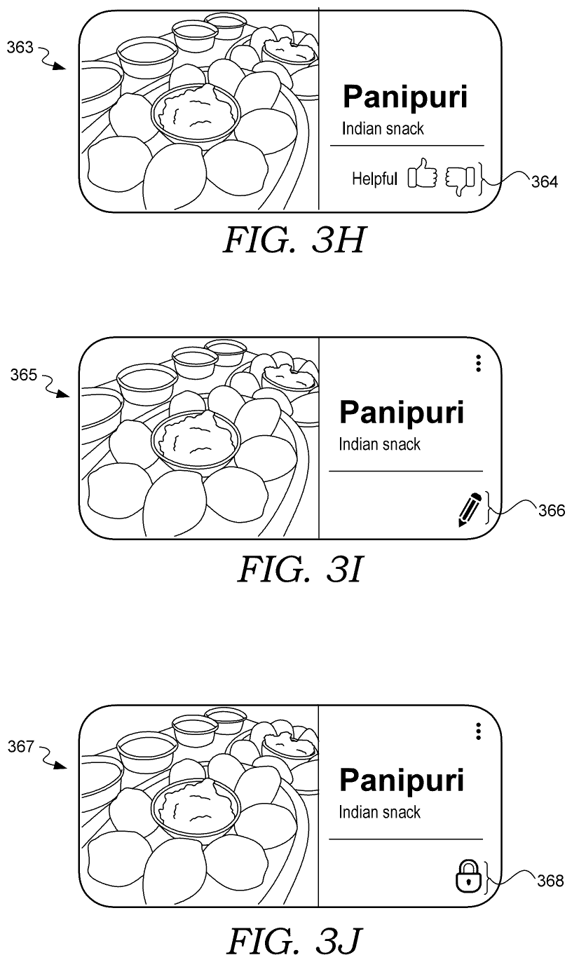

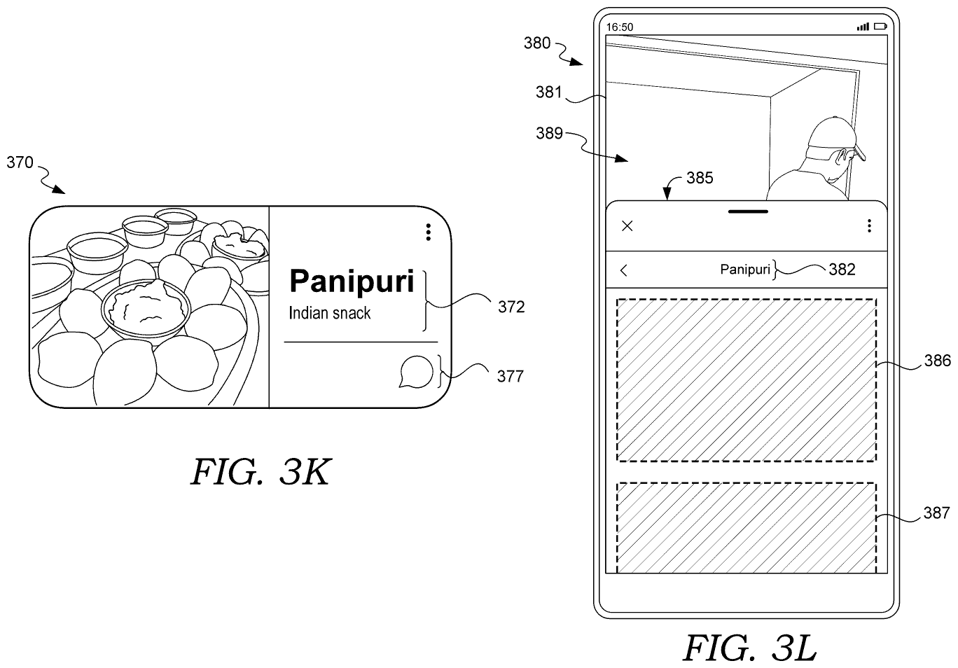

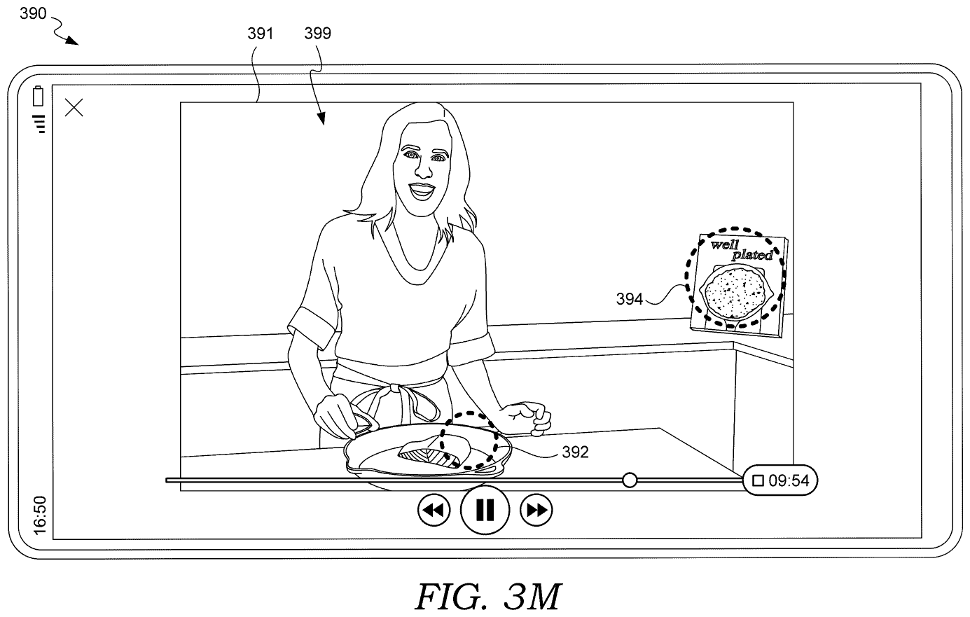

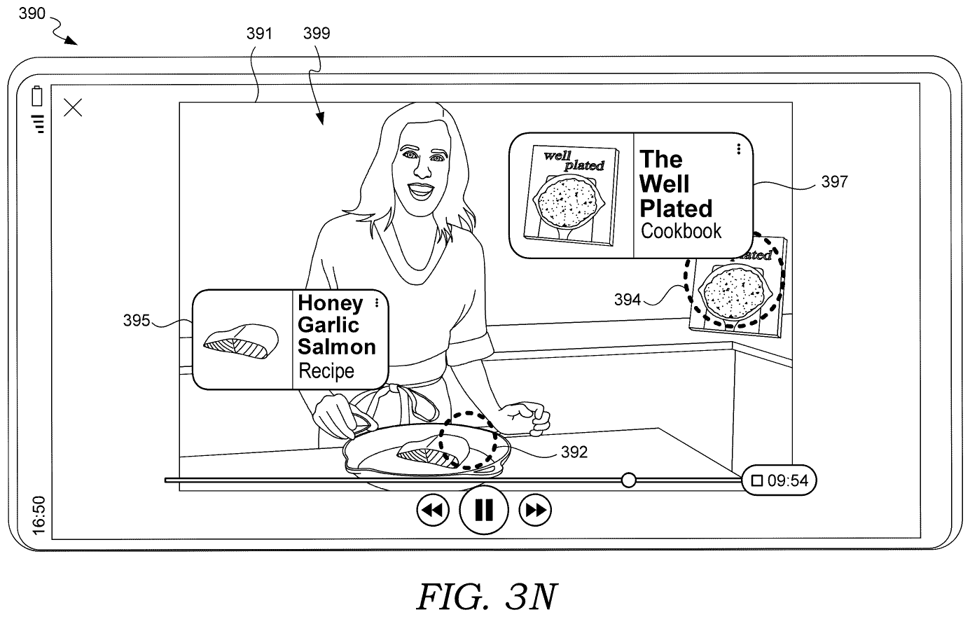

As further described herein, an ICC can be presented in a minimized size format in order to minimize obstruction of an underlying video, but still signal to a viewer that supplemental information, such as context regarding the video, is available. For example, as shown in FIG. 3F, ICC 335 depicts an entity name 332 and an image regarding an entity to which the ICC 335 corresponds in the video content. Here ICC 335 corresponds to the entity panipuri, as indicated in the entity name 332, which is an object depicted in the video 341. Similarly, ICC 347 depicts an entity name 348 and an image regarding an entity to which ICC 347 corresponds in the video content. Here ICC 347 corresponds to the entity Delhi, as indicated in the entity name 348, which is a location depicted in the video 341.

Upon an interaction with the ICC by the viewer, such as by clicking, touching, hovering over, or otherwise engaging with the card, the supplemental information is presented. In some embodiments, the supplemental information is presented via a supplemental content window that is an element of a graphical user interface. For example, according to one embodiment, upon a viewer tapping an ICC, the ICC expands in size to present a supplemental content window that includes the supplemental information. In another embodiment, upon a viewer tapping an ICC, a supplemental content window is presented over or adjacent to the video, and may be presented as a separate user interface element from the ICC. In particular, a supplemental content window may be presented in a layer or as an overlay on top of or adjacent to the video, which may pause or continue to play, depending on the implementation. For example, as shown in FIG. 3G, upon interacting with an ICC, such as ICC 335 in FIG. 3F, supplemental content window 355 is presented over video 341 for an entity, as indicated at 352 (here, panipuri). The supplemental content window 355 includes a depiction of supplemental information 356 regarding the entity, as indicated at 352. For example, the depiction of supplemental information 356 may comprise a description of panipuri. In this way, a supplemental content window, such as supplemental content window 355 in FIG. 3F, provides further details about an entity or subject referenced on the ICC, such as panipuri, where a viewer has requested further details by interacting with the ICC.

In various embodiments, ICCs are dynamically presented based on predefined presentation criteria, such as duration of time or temporal markers in a video, detected events in a video, or recognized objects within the video that correspond to an entity indicated in the ICC. These presentation criteria specify a condition for which an ICC is presented. By way of example and without limitation, presentation criteria include temporal criteria, such as criteria specifying a time in the video that a particular ICC should be presented or for how long an ICC should be presented; event detection criteria, such as criteria specifying that an ICC should be presented upon detection of an event in the video; and object detection criteria specifying that an ICC should be presented upon detection of an object in the video. For instance, a temporal criterion may be used for an ICC with an entity that is a location, such that the ICC for a location of a video scene is presented for several seconds starting at the beginning of the video scene. In a similar manner, an object detection criterion may be used for an ICC with an entity that is an indication of an object in the video, such that the ICC for the object in the video is presented whenever the object appears and is detected in the video, or the first time the object appears and is detected. Some embodiments utilize video object detection logic that programmatically determines the presence of an object in the video corresponding to the entity, as further described herein. This enables an ICC to be associated with specific content within the video, such as a person, object, or event depicted in the video or a location associated with the video.

In some embodiments, presentation criterion for an ICC are determined automatically based on the entity type of the entity indicated by the ICC. For example, for a location entity, a temporal criterion may be automatically applied, and for an entity corresponding to an object in the video, an object detection criterion may be applied. However, it is contemplated that in some embodiments, the ICC creator can specify a particular presentation criterion (or criteria) for an ICC. Similarly, where presentation criterion are determined automatically, an ICC creator can configure the presentation criterion. For example, for a temporal criterion, the ICC creator can specify a time of presentation and/or duration of presentation for the ICC. Likewise, for an object detection criterion, an ICC creator can specify whether the ICC is presented only the first time the object is detected in the video, or each time the object is detected in the video.

In various embodiments, the supplemental information is generated using a query to a knowledge base, which may include a search engine or language model. For example, in some embodiments, the knowledge includes or utilizes a language model, such as a large language model (LLM), medium language model (MLM), or small language model, to facilitate generation of the supplemental information. Moreover, the supplemental information may be determined at the time a viewer engages with the card via an interaction, rather than determined at an earlier time when the ICC is created. Accordingly, the data used for presenting an ICC, referred to herein as content card data, is small. In particular, some embodiments of content card data for a particular ICC include an indication of the entity and a presentation criterion specifying a condition under which the ICC is presented. Advantageously, this light data footprint enables a content card data to be stored in a video header or in metadata associated with the video, in some embodiments. Additionally, the creation of a content card is simplified because the card creator is not required to author the supplemental information. Further still, the supplemental information is more likely to be current, rather than out-of-date, because it is determined at the time of the interaction by a viewer.

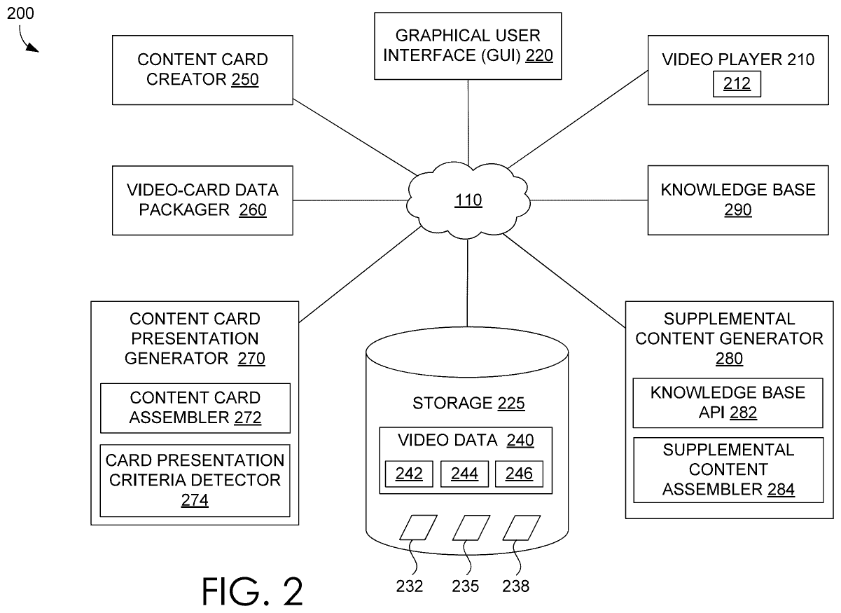

In some embodiments, an ICC comprises, or has associated therewith, one or more card properties. A card property specifies an aspect of the ICC for presentation or other information or functionality to be included in an ICC. For example, and without limitation, card properties include formatting aspects such as a size, orientation, or location for presenting the ICC with respect to the location of the video; attribution to the original creator of the ICC; feedback mechanisms; editing capabilities or an indication that an ICC is not editable; or functionality for viewers to input comments regarding an ICC. Some example indications of various card properties are depicted as items 364, 366, and 368 in FIGS. 3H through 3J, and item 377 in FIG. 3K, and are described further in connection with FIGS. 3H through 3K. In some embodiments, default card properties are applied to an ICC upon its creation, or an ICC creator can specify one or more card properties for a particular ICC. In some embodiments, card properties are specified in configuration settings, such as configuration settings 238 described in connection to FIG. 2. These card properties further contribute to a more personalized and interactive viewing experience, allowing viewers to engage with the video content on an even deeper level.

Accordingly, this disclosure provides technologies that enable the creation of content cards, such as ICCs, that can be interacted with by a viewer during video viewing or playback. In a first aspect and at a high level, a content card is created for presentation during a video. The video may comprise a live stream, video file, pre-recorded video media, or streaming video media. The video is accessed, and a content card is determined to be associated with the video. For example, the content card may be determined based on an indication in the header of the video or in metadata associated with the video. In this way, a content card can be utilized with various forms of video media across different platforms and video formats, enhancing the accessibility and reach of the disclosed technology. The content card includes an indication of an entity associated with the video and a presentation criterion specifying a condition for presenting the content card.

Based on the condition corresponding to the presentation criterion being satisfied, the content card is presented. For example, the content card is presented via a user interface layer over the video, while the video continues to play. Upon detecting, via the user interface, a user interaction with the content card, such as a viewer touching or clicking the content card, the entity corresponding to the card is utilized to generate supplemental content for presentation to the viewer. In particular, a query input is generated using the entity. Then, using the query input, a query operation is performed on a knowledge base. A query result is received from the knowledge base and used to generate the supplemental information. In some embodiments, the knowledge base comprises a search engine, and the query result is the first returned search result or one of the top ranked search results. In other embodiments, the knowledge base comprises a language model, such as an LLM, the query input includes an instruction for the language model to generate a summary of the entity, and the query result comprises the language model output that is the generated summary. The supplemental information generated from the query result is then presented via a supplemental content window that is a user interface element. The supplemental content window is presented over or adjacent to the video.

### Overview of Technical Problems, Technical Solutions, and Technological Improvements

As described previously the richness of video content often hinges on the viewer's ability to fully understand and appreciate the context within which it is presented. This understanding can be impeded by a lack of information about the video, such as the context, location, objects, or people featured within it. While some viewers may possess prior knowledge that allows them to recognize specific places or objects in a video, others may find themselves without the same level of understanding. Conventional video viewing technologies provide at best only limited technical functionality for viewers to receive or contribute to understanding contexts of the video. For example, a video creator or publisher can add narration, subtitles or a description to the produced video content to provide the understanding to the viewer, but this added information becomes part of the video (or audio) and requires recoding and republishing the video, essentially resulting in a new version of the original video content. Additionally, the added information is static and not interactive, meaning that subsequent viewers will receive the same information regardless of their individual knowledge, interest level, or how they view the video. Online video sharing platforms may include functionality for viewer-provided comments or captions, but the comments are provided with regard to an entire video, and not with regard to certain entities of the video, such as an object, event, person, or location depicted during a portion of the video. Moreover, for the comments to be viewable to users, the video must be hosted or viewed on the same platform as the comments. The video with the comments cannot be shared or embedded in a presentation, feed, or on another platform.

Some online video sharing platforms may provide information cards for videos enabling video creators to provide supplemental information, but these conventional technologies also have deficiencies. For example, the information cards may only be added by the video creator or publisher alone, leaving subsequent viewers without the ability to contribute additional context. Moreover, these information cards are restricted to the platform on which the video is created, published, or hosted, thus limiting their utility across different platforms and environments. Yet another limitation with these information cards is that the supplemental content is fixed at the time the video is published, and thus the content provided to a viewer must be determined at the time the video is produced; it will not change. Consequently, this supplemental content can become outdated, or stale, or links to external resources can become dead links.

Yet another limitation of conventional technology is the static nature of information card presentation, often requiring the creator to set a specific time or duration for display. Furthermore, the conventional information cards redirect users away from the video to external content, such as another video or a webpage, which disrupts the viewing experience. Consequently, these information cards are not useful for providing context to a particular video. Moreover, when video creators add static information to their content, it necessitates recoding and republishing the video, effectively creating a new version. This process is not just time-consuming but also results in a one-size-fits-all approach where all viewers receive the same information. Additionally, conventional clickable links, like those found in some video platforms or information cards, redirect viewers away from the video, thereby disrupting their viewing experience. Further these information cards are also typically restricted to use by the video's creator or publisher, limiting the ability of the broader viewer community to contribute to the video's context.

In contrast, embodiments of the ICC technology provided herein improve the functionality of video content by enabling viewers or a video creator to provide interactive and contextually relevant information to other viewers. In particular, various embodiments of this ICC technology provide a substantial improvement over existing video viewing technologies by enabling interactive, content cards, which may be viewer generated in some implementations, and may provide portability across various platforms, in some implementations, thereby offering dynamic presentation tied to video content, maintaining viewer engagement, and delivering current and dynamic supplemental information.

Some embodiments of the ICC technology allow any viewer to add content cards onto videos, with the card data-comprising merely an indication of an entity and a presentation criterion-being lightweight enough to be stored in the video file header. This portability is a notable advantage, as ICC content can remain with the video file, allowing it to be shared and interacted with across various platforms. For example, an ICC-enabled video could be shared on Microsoft Feed, Teams, or LinkedIn, enabling viewers to add and interact with ICCs, thereby democratizing the contextualization of video content.

Another improvement related to this advantage is that some embodiments of the ICC technology generate the supplemental information provided to a viewer at the time of viewer interaction. In this way, the ICC technology provides supplemental information that is current and somewhat dynamic, reflecting any changes in search results or knowledge base outputs. For example, if a query result changes, then different supplemental content is presented to the viewer when interacting with an ICC. As a result, viewers are provided with the latest information without concerns about dead links or outdated content.

Still another improvement is that some embodiments of the ICC technology dynamically present ICCs based on the content of the video itself, such as the appearance of an object or the occurrence of an event. Moreover, the ICC technology can maintain viewer engagement by overlaying over the video the ICC or the supplemental information provided when a viewer interacts with an ICC, thereby allowing the viewer to continue watching.

### Additional Description of the Embodiments

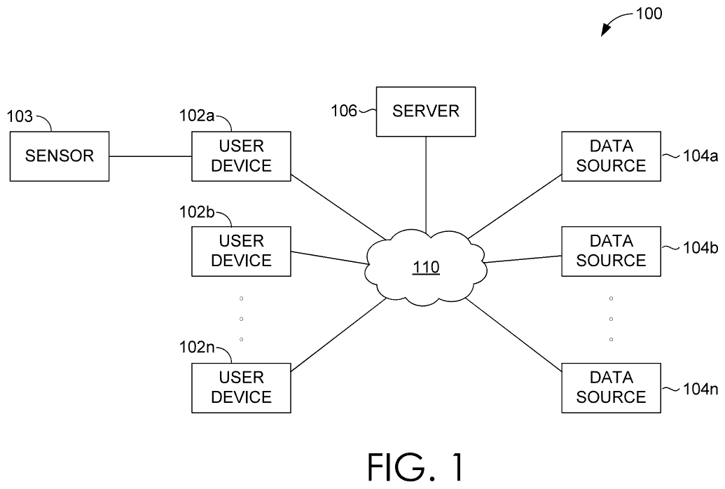

Turning now to FIG. 1, a block diagram is provided showing an example operating environment 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

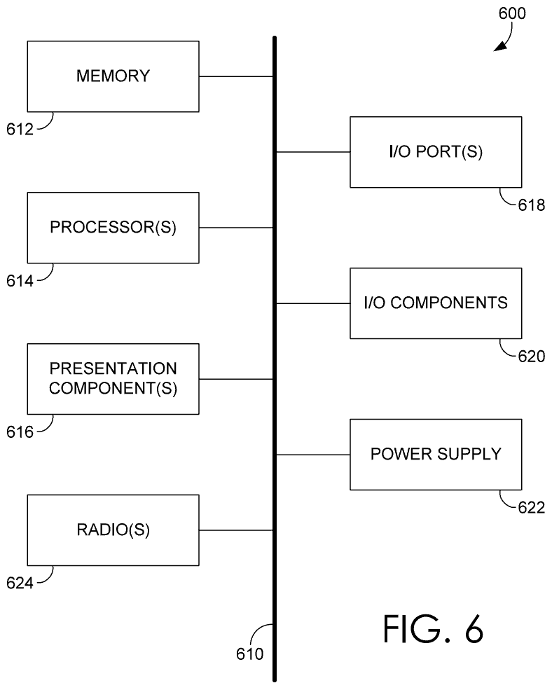

Among other components not shown, example operating environment 100 includes a number of user computing devices, such as user devices 102a and 102b through 102n; a number of data sources, such as data sources 104a and 104b through 104n; server 106; sensors 103; and network 110. It should be understood that operating environment 100 shown in FIG. 1 is an example of one suitable operating environment. Each of the components shown in FIG. 1 is implemented via any type of computing device, such as computing device 600 illustrated in FIG. 6, for example. In one embodiment, these components communicate with each other via network 110, which include, without limitation, one or more local area networks (LANs) and/or wide area networks (WANs). In one example, network 110 comprises the internet, intranet, and/or a cellular network, amongst any of a variety of possible public and/or private networks.

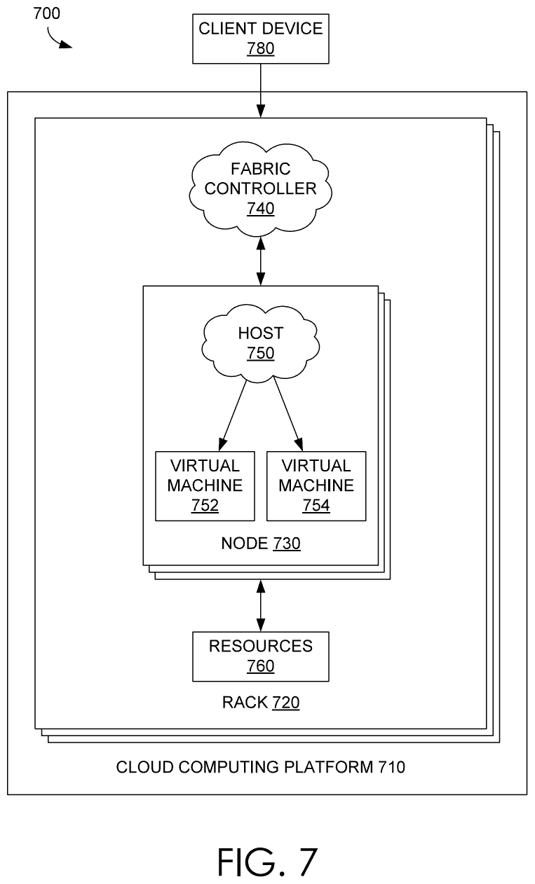

It should be understood that any number of user devices, servers, and data sources can be employed within operating environment 100 within the scope of the present disclosure. Each may comprise a single device or multiple devices cooperating in a distributed environment, such as the distributed computing system 700 in FIG. 7. For instance, server 106 is provided via multiple devices arranged in a distributed environment that collectively provide the functionality described herein. Additionally, other components not shown may also be included within the distributed environment.

User devices 102a and 102b through 102n can be client computing devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate components.

In some embodiments, user devices 102a and 102b through 102n comprise any type of computing device capable of use by a user. For example, in one embodiment, user devices 102a and 102b through 102n are the type of computing device 600 described in relation to FIG. 6 herein. By way of example and not limitation, a user device is embodied as a personal computer (PC), a laptop computer, a mobile device, a smartphone, a tablet computer, a smart watch, a wearable computer, a personal digital assistant (PDA) device, a virtual-reality (VR) or augmented-reality (AR) device or headset, a video player, a smart television, a handheld communication device, a gaming device or system, an entertainment system, a consumer electronic device, a workstation, any other suitable computer device, or any combination of these delineated devices. Some embodiments of user devices 102a and 102b through 102n integrate, or have associated therewith, sensors, such as sensor 103. For example, some embodiments of a user device 102a have a touch screen configured with sensors to sense and receive user input from touching various user interface elements presented on the screen. For instance, some embodiments of user device 102a use sensor 103 to detect an interaction with an ICC that is presented via the user interface.

In some embodiments, data sources 104a and 104b through 104n comprise data sources and/or data systems, which are configured to make data available to any of the various constituents of operating environment 100 or system 200 described in connection to FIG. 2. For instance, in one embodiment, one or more data sources 104a and 104b through 104n provide (or make available for accessing) video data, such as video data 240 of FIG. 2 and/or one or more of the data sources 104a and 104b through 104n that provide data associated with a knowledge base, such as knowledge base 290.

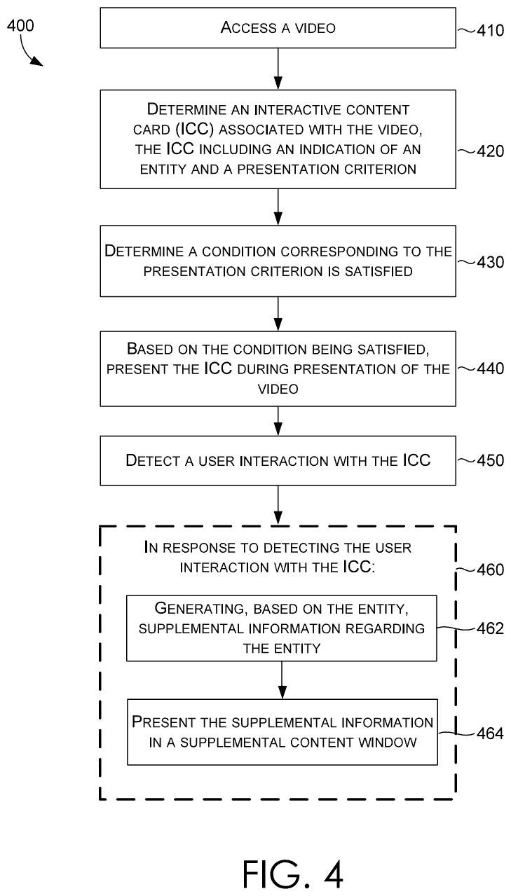

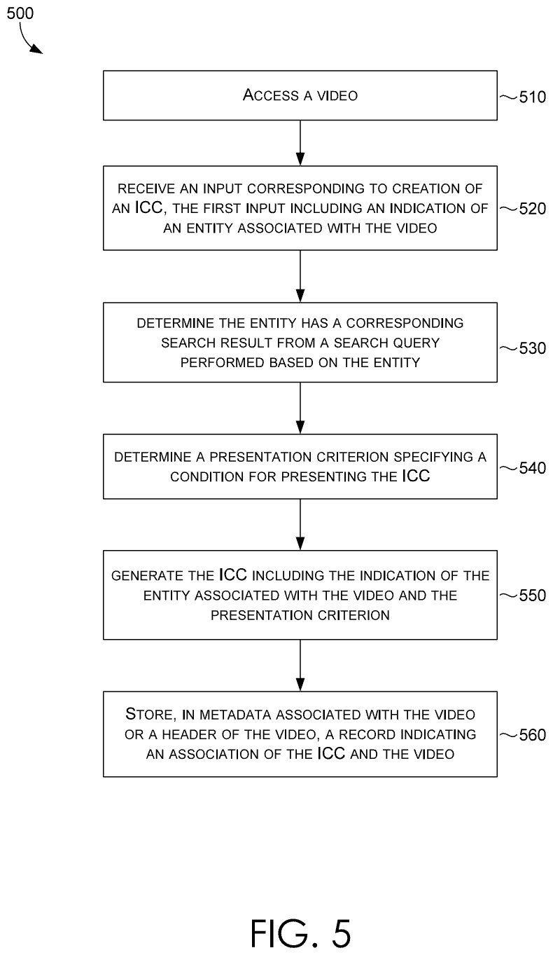

Operating environment 100 can be utilized to implement one or more of the components of system 200, as described in FIG. 2, including components for accessing and processing video data, creating and presenting an ICC; detecting an interaction with an ICC, and/or generating supplemental information for presentation. Operating environment 100 also can be utilized for implementing aspects of methods 400 and 500 in FIGS. 4 and 5 respectively.

Referring now to FIG. 2, with continuing reference to FIG. 1, a block diagram is provided showing aspects of an example computing system architecture suitable for implementing an embodiment of the present disclosure and designated generally as system 200. System 200 represents one example of a suitable computing system architecture for enhancing digital video content with interactive content cards (ICCs). Other arrangements and elements can be used in addition to or instead of those shown, and some elements may be omitted for the sake of clarity. Further, as with operating environment 100, many of the elements described herein are functional entities that may be implemented as discrete or distributed components or in conjunction with other components, and in any suitable combination and location. In one example, the computing device 600 of FIG. 6 or the distributed computing system 700 of FIG. 7 perform aspects of the system 200 of FIG. 2.

Example system 200 includes network 110, which is described in connection to FIG. 1, and which communicatively couples components of system 200, including video player 210, graphical user interface (GUI) 220, content card creator 250, video-card data packager 260, content card presentation generator 270, supplemental content generator 280, knowledge base 290, and storage 225. Some embodiments of system 200 components include: video player 210 (including subcomponent 212), GUI 220, content card creator 250, video-card data packager 260, content card presentation generator 270 (including its subcomponents 272 and 274), supplemental content generator 280 (including its subcomponents 282 and 284), and knowledge base 290, which are embodied as compiled computer instructions or functions, program modules, computer software services, or an arrangement of processes carried out on one or more computer systems, such as computing device 600, described in connection to FIG. 6.

In some embodiments, the functions performed by components of system 200 are associated with one or more computer applications, services, or routines, such as a video player application, video recording or editing application, social media application or platform, communications application, online meeting application, workplace collaboration application, or chat application. In some of these embodiments, the functions operate to generate or present and support the operation of ICCs. Certain applications, services, or routines operate on one or more user devices (such as user device 102a of FIG. 1) or servers (such as server 106 of FIG. 1). Moreover, in some embodiments, these components of system 200 are distributed across a network, including one or more servers (such as server 106 of FIG. 1) and/or client devices (such as user device 102a of FIG. 1) in the cloud, such as described in connection with FIG. 7, or reside on a user device, such as user device 102a of FIG. 1. Moreover, functions performed by these components or services carried out by these components can be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example and without limitation, illustrative types of hardware logic components include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), and so forth. Additionally, although functionality is described herein with regard to specific components shown in example system 200, it is contemplated that in some embodiments, functionality of these components is shared or distributed across other components.

Continuing with FIG. 2, graphical user interface (GUI) 220 is generally responsible for presenting video content and presenting an ICC in conjunction with the video content. GUI 220 is also responsible for presenting a supplemental content window having supplemental information about an entity corresponding to an ICC. In various implementations, GUI 220 is embodied as a presentation component, such as presentation component 616 described in FIG. 6, and/or an I/O component, such as I/O component 620 described in FIG. 6. In particular, GUI 220 receives video content to be presented. The video content may be received as video data 240 in storage 225 or from a video player 210. GUI 220 also receives, from content card presentation generator 270, one or more aspects of an ICC to be presented with the video. These aspects include presenting a representation of an ICC and presenting a representation of a supplemental content window that includes supplemental information in response to detecting a viewer interaction with an ICC. Some embodiments of GUI 220 present an ICC over the video content as an overlay using a layer, based on presentation instructions received from content card presentation generator 270. Similarly, some embodiments of GUI 220 present a supplemental content window in a similar manner according to presentation instructions received from supplemental content generator 280. For example, the video content may continue to play as an ICC, or a supplemental content window is presented over or adjacent to the playing video.

Embodiments of GUI 220 include functionality for receiving input data from a user who is creating an ICC, as described in connection with content card creator 250. In some instances, GUI 220 presents user interface elements to facilitate receiving input to create the ICC, as further described in connection to content card creator 250. Embodiments of GUI 220 also include functionality for detecting a user interaction with an ICC. For instance, GUI 220 detects touching or otherwise engaging with an ICC by a user who is viewing a video having an ICC presented thereon. Accordingly, some embodiments of GUI 220 use a sensor, such as sensor 103 described in FIG. 1 that is associated with user device 102a also described in FIG. 1. The sensor is operable to sense or otherwise detect a user interaction, such as a touch, click, hover-over, or other engagement with an ICC that is being presented via GUI 220. Based on this detection of a user interaction with a particular ICC that is being presented, embodiments of GUI 220 provide an indication of the interaction with the particular ICC. For example, the indication of the user interaction is provided to supplemental content generator 280, which, in response to receiving the indication of the interaction, determines supplemental information and generates instructions for GUI 220 to present a supplemental content window that includes supplemental information regarding the entity corresponding to the particular ICC with which the user interacted.

Content card creator 250 is generally responsible for facilitating the creation of ICCs. This includes functionality for receiving and processing an input from a user, who is creating an ICC, in order to generate data used for presenting the ICC. As described previously, this data is referred to herein as content card data. Some embodiments of content card creator 250 provide instructions for GUI 220 to present user interface elements operable to receive input from a user who is creating a content card for a video. Examples of these user interface elements are described below in connection with the example of FIGS. 3B through 3E. Further, these user interface elements may be presented in conjunction with the video content, as exemplified in FIGS. 3B through 3E.

Embodiments of content card creator 250 receive an input from a user, such as a viewer of a video who intends to create an ICC. The input indicates that the user intends to create a content card and includes an indication of an entity. For example, the entity may comprise a person, object, location, or event depicted in or associated with the video. In some embodiments, the user inputs an indication of the entity into a user interface element for creating an ICC. In some embodiments, the user input also includes a presentation criterion that specifies a condition for which the ICC is presented. Further still, some embodiments of the user inputs include one or more card properties, as further described herein, such as a formatting aspect or feature of the ICC.

With reference to FIGS. 3A through 3C and continuing reference to FIG. 2, an example is illustratively depicted of an ICC creation using an embodiment of content card creator 250. Turning first to FIGS. 3A and 3B, a user device 300 is depicted having a GUI 301 presenting a video 309. GUI 301 comprises a graphical user interface such as described in connection to GUI 220, and user device 300 comprises a computing device such as user device 102a, described in FIG. 1. The video 309 shows a person making panipuri, which is an Indian street food. In this example, a user viewing the video (or the user creating the video) desires to create an ICC explaining contextual information to other viewers, such as information about panipuri. Accordingly, the user provides an input to GUI 301 to create an ICC. In the example depicted in FIG. 3A, the user selects a user interface (UI) element 305 of GUI 301, which initiates the process for creating an ICC. In this example, in response to the user selecting UI element 305, a blank ICC 310 is presented via GUI 302, as depicted in FIG. 3B. The blank ICC 310 indicates to the user that the user has initiated the process for creating an ICC. Subsequently, the user is presented user interface elements to receive an input regarding the creation of the ICC, such as depicted in FIG. 3C. In some embodiments, upon the user providing an input to create an ICC, the user is provided the user interface elements to receive input regarding the creation of the ICC, such as depicted in FIG. 3C.

Turning to FIG. 3C, a set of UI elements referred to as ICC-creation UI elements 325 are illustratively depicted. ICC-creation UI elements 325 are configured to receive user input for the creation of an ICC. In the example of FIG. 3C, ICC-creation UI elements 325 includes field 322 for a user to input an entity for the ICC. ICC-creation UI elements 325 also includes presentation criterion input 324 providing functionality for the user to input a presentation criterion for presenting the ICC. In this example of FIG. 3C, the user can select between three different types of presentation criterion: a time (or temporal) criterion, an event detection criterion, or an object detection criterion.

Generally, embodiments of content card creator 250 determine a presentation criterion for the ICC that is being created. As described previously, a presentation criterion specifies a condition for which the ICC is presented. In some embodiments, content card creator 250 determines a presentation criterion based on input received from a user who is creating the ICC, such as described in connection with FIG. 3C. For example, the user might specify that an ICC is to be presented for the first ten seconds of the video, or for ten seconds starting at the one minute and twenty second mark (or another particular time) in the video. This example presentation criterion is a temporal criterion. In other embodiments, content card creator 250 determines the presentation criterion based on an entity type for the entity provided as input by the user. For example, in one embodiment, where the entity is an object in the video, content card creator 250 determines the presentation criterion to be based on a detection of the object in the video. In particular, certain embodiments of the ICC technologies provided herein use video object detector logic 235 to detect objects in the video. In these embodiments, a presentation criterion can be automatically determined (or can be specified by the user during the creation of the ICC) to be based on a detection in the video of the object corresponding to the entity. Similarly, where the entity corresponding to the ICC is an event, video features corresponding to the event are detected using video object detector logic 235.

Similarly, where the entity is a location in the video, some embodiments of content card creator 250 determine a presentation criterion based on a location associated with the video. In some of these embodiments, video metadata 246 associated with the video includes location data for the video that is accessed and used by content card creator 250 to determine a location. Alternatively or in addition, some embodiments of content card creator 250 use features of the video, such as objects, signs, business names, buildings, or other features to determine a likely location of the video. For example, some embodiments apply image recognition techniques to match image data of a video with location-indexed images in a database. Still further, where video is being produced on a computing device (such as a live stream video being produced on a mobile device) and the same computing device is being used to create the ICC, then some embodiments of content card creator 250 use location data provided by the computing device to determine a likely location of the video.

Upon receiving the user input specifying an entity, and in some embodiments, also specifying a content card property, and upon determining a presentation criterion, content card creator 250 creates content card data for the ICC. Accordingly, the output of content card creator 250 comprises content card data that includes at least an indication of an entity and a presentation criterion. In some embodiments, the content card data may also include one or more card properties. The content card data may be stored as content card data 232 within storage 225. Additionally, the content card data is utilized by other components of system 200, such as video-card data packager 260 and content card presentation generator 270.

Continuing with FIG. 2, video-card data packager 260 is generally responsible for integrating content card data with video data to facilitate the presentation of interactive content cards (ICCs) in conjunction with video content. Embodiments of video-card data packager 260 receive content card data and video data. The content card data may be received from content card creator 250 or from content card data 232 in storage 225. The video data may be received from a video data 240 in storage 225, or from a video source, such as a data source 104a, described in FIG. 1. The video data 240 comprises prerecorded video media, a live video feed, a video file, or streaming video media. In some embodiments, video data 240 includes video media content 242, a video header 244, and video metadata 246.

Video-card data packager 260 processes the content card data 232 and video data 240 to embed or link the content card data 232 with the video data 240. For example, in some embodiments, content card data 232 is stored within the video header 244, which is part of the video file structure, or within video metadata 246, which may accompany the video file or stream. In some implementations, rather than storing the content card data 232 directly within the video file or metadata, a pointer is stored in the video header or the metadata, such that the pointer references externally stored content card data 232. This allows for a more dynamic and flexible association between the video and the ICCs, as content card data can be updated or modified without altering the video file itself. The output of video-card data packager 260 comprises packaged video data, which now includes or is associated with content card data. This packaged video data is stored in video data 240 within storage 225 and/or is used by other components of system 200.

Content card presentation generator 270 is generally responsible for assembling an ICC and determining that the ICC should be presented by GUI 220, as well as providing to GUI 220 the ICC and instructions for its presentation. Embodiments of content card presentation generator 270 receive content card data and video data. The content card data may be received from content card data 232 or from another component of system 200, such as content card creator 250. The video data may be received from video player 210 or from video data 240 in storage 225. In some embodiments, content card presentation generator 270 also accesses default card properties, which may be accessed from configuration settings 238 in storage 225.

Content card presentation generator 270 processes the content card data to assemble an ICC for presentation and determines under what condition the ICC is to be presented. In some embodiments, the ICC is assembled according to one or more card properties associated with the ICC card data. As described herein, the card properties can include aspects regarding the formatting of the ICC, such as size, orientation, location with respect to the video, transparency, and design or layout, as well as other properties of the ICC. For instance, other properties can include whether the ICC can be edited, or other functionality present in the ICC, such as a viewer feedback mechanism or viewer commenting functionality. Similarly, in some instances, an ICC is assembled and provided to the GUI 220 with instructions for presentation where the instructions specify aspects of the ICC formatting such as size, orientation, or location with respect to the underlying video.

In particular, an ICC may be assembled according to a card property provided by a user who is creating the ICC. Alternatively or in addition, it may be assembled according to a default card property, such as a default size, orientation, or default ICC functions or features. In some embodiments, different default card properties are associated with different entity types for the entity corresponding to an ICC. Thus, for example, where the entity is an object, an ICC can be assembled using a specific, default card property (or properties) for ICCs with object entities. Similarly, where the entity is a location, then the ICC corresponding to that entity is assembled using a specific, default card property (or properties) for ICCs with location entities. In some embodiments, default card properties are specified by configuration settings 238 in storage 225. For example, a user or an administrator specifies default card properties in configuration settings 238. Further, in some embodiments, the card properties stored in configuration settings 238 include ICC templates. An ICC template specifies one or a plurality of card properties.

Content card presentation generator 270 also processes video data to determine if a presentation criterion specified in the content card data is satisfied and thus an ICC should be presented. Additional details of this operation are described in connection to card presentation criteria detector 274.

As shown in example system 200, content card presentation generator 270 comprises content card assembler 272 and card presentation criteria detector 274. Content card assembler 272 is generally responsible for constructing or assembling an ICC to be presented by GUI 220 and providing the ICC for presentation by GUI 220. In some embodiments, this includes packaging the ICC in a layer and/or providing instructions so that GUI 220 can present the ICC over or adjacent to the video, which may be continuing to play.

Content card assembler 272 receives the content card data and in some instances default card property information. From the content card data, content card assembler 272 determines the entity and presentation criterion for an ICC, as well as any card properties for the ICC that specify a presentation aspect or formatting aspect, such as ICC size, ICC location on the video, how long the ICC is presented, or the like, and assembles the ICC accordingly. Subsequently, upon receiving an indication from card presentation criteria detector 274 that a presentation criterion for the ICC is satisfied, content card assembler 272 provides instructions for GUI 220 to present the ICC. The instructions may include presenting the ICC in a video overlay enabling presentation of the ICC over the video, such as within a layer or container that is rendered on top of the video. For example, an overlay effect can be created in Hyper Text Markup Language (HTML) using a <div> function.

Card presentation criteria detector 274 is generally responsible for detecting that a presentation criterion for presenting a particular ICC is satisfied. Card presentation criteria detector 274 determines that a condition for presenting a particular ICC is satisfied and thus the ICC is to be presented, or the condition is not satisfied and thus the ICC is not to be presented. Card presentation criteria detector 274 receives video data and card data. Using the presentation criterion specified in the card data, the video data is processed to determine if the presentation criterion is satisfied and thus the ICC is to be presented. For example, if the presentation criterion is a temporal criterion that specifies a time for presenting the ICC, then card presentation criteria detector 274 processes the video to determine when the time condition is satisfied and upon determining that it is satisfied, provides an indication to content card assembler 272 (or more generally to content card presentation generator 270) that the ICC is to be presented.

Some embodiments of card presentation criteria detector 274 use video object detector logic 235, as described herein, to detect objects or events in the video data. For example, where the presentation criterion is an object detection criterion that specifies that the ICC is to be presented upon detection of an object in the video, embodiments of card presentation criteria detector 274 can use video object detector logic 235 to detect that the object is (or is not) in the video. The output of card presentation criteria detector 274 is an indication provided to content card assembler 272 (or more generally to content card presentation generator 270) that the ICC is to be presented.

Video object detector logic 235 comprises computer instructions and may further including rules, conditions, associations, classification models, or other criteria for programmatically detecting objects or events in video data. Video object detector logic 235 may take different forms depending on the particular entity type or video data, and may comprise combinations of the logic described herein. Some embodiments of video object detector logic 235 include a video indexer, such as Azure Video Indexer. Video indexers utilize artificial intelligence to analyze video and audio content, extracting valuable metadata such as speech, text, faces, and scenes. Video indexing supports object detection by detecting, indexing, and tracking visual elements in a video.

Some embodiments of video object detector logic 235 include object tracking logic, which uses object tracking algorithms or object detection algorithms. For example, these algorithms include the Histogram of Oriented Gradients (HOG) technique, Region-based Convolutional Neural Networks (R-CNNs), Faster R-CNNs, a Single Shot Detector (SSD), YOLO (You Only Look Once), optical flow, Simple Online Realtime Tracking (SORT), deep SORT, and similar computer processes. In this way, video object detector logic 235 enables card presentation criteria detector 274 (or more generally, content card presentation generator 270) to accurately identify and track visual elements within the video, and use the detection of the visual elements to direct the presentation of ICCs. By leveraging video object detector logic 235, card presentation criteria detector 274 can provide an indication for when a particular object, corresponding to an entity of an ICC, is detected within the video stream.

Continuing with FIG. 2, video player 210 is generally responsible for playing video content via GUI 220. Video Player 210 receives video data 240, which may be received from video data 240 in storage 225, or directly from a video source, such as a data source 104a, described in FIG. 1. The video data 240 comprises prerecorded video media, a live video feed, a video file, or streaming video media. In some embodiments, video data 240 includes video media content 242 and a video header 244. In some embodiments, video data 240 further includes video metadata 246.

Video player 210 is implemented as a stand-alone computer application or as part of another computer application or platform, such as within a social media platform or social media application, feed, communications application such as an online meeting application, web browser, app, subscription video app, mobile device video app, or other computing application. In operation, video player 210 processes the video data 240, utilizing video codecs such as a Moving Picture Experts Group (MPEG) standard (for example, Advanced Video Coding (AVC), H.264, MPEG-4 Part 10, High Efficiency Video Coding (HEVC)), VP9, AOMedia Video 1 (AV1), AOMedia Video 2 (AV2), among others, to decode the video data and generate a playable video for presentation by GUI 220. In some implementations, video player 210 also processes the video data 240 to determine content card data for an ICC associated with the video. In other implementations, an ICC-reading service 212 processes the video data 240 to determine content card data for an associated ICC. In particular, the video data 240 is processed to determine card data from a video header 244 or from video metadata 246, or to determine a pointer to externally stored card data. ICC-reading service 212 comprises a computing service or computing application that reads ICCs associated with a video and operates as part of video player 210 or as a separate computing service that operates with video player 210. For example, ICC-reading service 212 can be implemented as a separate app or as a software plug-in to provide functionality for reading ICCs associated with video. The content card data is provided to content card presentation generator 270, where it may be used to generate an ICC.

Knowledge base 290 comprises an application or service for providing information in response to a request. In some embodiments, knowledge base 290 is implemented as a search engine or a language model, such a generative pre-trained transformer (GPT) series of LLM model or bidirectional encoder representations from transformers (BERT) model. In some embodiments, knowledge base 290 comprises a search engine and/or one or more language models. Knowledge base 290 receives a request for information in the form of a query (sometimes referred to herein as a query input) and operates on the query to provide a query result. The query result includes information retrieved or generated by the knowledge base 290 that is responsive to the query.

In particular, as shown in system 200, knowledge base 290 receives a query input from supplemental content generator 280. The query may be received from an application programming interface (API) for the knowledge base 290, such as knowledge base API 282. As described herein, the query input includes an indication of an entity corresponding to an ICC. The query input is received by knowledge base 290 and used to perform a query operation. The query operation produces a query result that is returned to knowledge base API 282 (or more generally, it is returned to supplemental content generator 280) where the query result is used by supplemental content generator 280 to generate supplemental information about an entity corresponding to an ICC.

Where knowledge base 290 is implemented as a search engine, the query input is received from knowledge base API 282 and used to perform a query operation using the search engine. The query operation produces a query result from the search engine that is returned to knowledge base API 282. In some embodiments, the query input includes an instruction to return only a portion of the query result such as the top ranked (or most relevant) result returned by the search engine, or a particular result returned by the search engine. For example, where the search engine returns multiple results from the query operation, the instruction can specify to take the result from a particular data source, such as a particular online encyclopedia or another predetermined source of information. Where knowledge base 290 is implemented as an LLM, the query input received from knowledge base API 282 includes an instruction to direct the LLM to generate a summary based on the entity indicated in the query input. Thus, the query operation uses the instruction in the query input to generate the summary by inputting the query input as a prompt to the LLM, and providing the output of the LLM, which is the generated summary, as the query result.

Continuing with FIG. 2, supplemental content generator 280 is generally responsible for assembling a supplemental content window and causing the supplemental content window to be presented via GUI 220. The supplemental content window is presented in response to receiving an indication from GUI 220 of an interaction with an ICC. The supplemental content window includes supplemental information that is generated based on an entity corresponding to the ICC indicated by the interaction.

Embodiments of supplemental content generator 280 receive content card data, which includes indications of an entity corresponding to an ICC. The content card data may be received from content card data 232, from another component of system 200, such as video player 210. Supplemental content generator 280 also receives from GUI 220 an indication of an interaction with an ICC. Supplemental content generator 280 processes the entity corresponding to the ICC to determine the supplemental information by performing a query operation using knowledge base 290. Supplemental content generator 280 then provides to GUI 220 a supplemental content window that includes the supplemental information and instructions for presenting the supplemental content window.

As shown in example system 200, Supplemental content generator 280 comprises knowledge base API 282 and supplemental content assembler 284. Knowledge base API 282 is generally responsible for interfacing with knowledge base 290. For example, knowledge base API 282 receives a query input from supplemental content assembler 284, and provides the query input to a knowledge base 290. Knowledge base API 282 then receives a query result from the knowledge base 290 and provides the query result to supplemental content generator 284.

Supplemental content assembler 284 is generally responsible for constructing or assembling a supplemental content window to be presented by GUI 220, including determining supplemental information for the supplemental content window. For instance, upon receiving from GUI 220 an indication that an ICC is interacted with, supplemental content assembler 284 determines the supplemental information regarding an entity corresponding to the ICC. Supplemental content assembler 284 then assembles the supplemental content window to include a representation of the supplemental information, and provides instructions for GUI 220 to present the supplemental content window.

Supplemental content assembler 284 determines the supplemental information using the entity indicated from the card data. In particular, Supplemental content assembler 284 generates a query input using the indication of the entity and provides the query input to knowledge base API 282. In some embodiments, the query input includes an instruction regarding a query operation to be performed by knowledge base 290. For example, where knowledge base 290 comprises an LLM, the query input instruction directs the LLM to generate a summary explanation regarding the entity indicated in the query input. Supplemental content assembler 284 receives from knowledge base API 282 the query result determined from knowledge base 290, and uses the query result to generate the supplemental information.

Supplemental content assembler 284 then assembles the supplemental content window to include a representation of the supplemental information, and provides instructions for GUI 220 to present the supplemental content window. In some embodiments, the instructions comprise computer instructions controlling the presentation of the supplemental content window. For example, the supplemental content window may be presented adjacent to the video or as a video overlay, thereby enabling presentation of the supplemental content window with the video, which continues to play, in some implementations. In one embodiment, the computer instructions include presenting the supplemental content window within a layer or container that is rendered on top of the video. For example, an overlay effect can be created in HTML using a <div> function.

Example system 200 of FIG. 2 also includes storage 225. Storage 225 generally stores information including data, computer instructions (for example, software program instructions, routines, or services), logic, profiles, and/or models used in embodiments described herein. In an embodiment, storage 225 comprises a data store (or computer data memory). Further, although depicted as a single data store component, storage 225 can be embodied as one or more data stores or in the cloud. In one embodiment, storage 225 is embodied as memory 612 of computing device 600 of FIG. 6.

As shown in example system 200 of FIG. 2, storage 225 includes video data 240, card data 232, video object detector logic 235, and configuration settings 238, each of which have been described previously.

With reference now to FIGS. 3A through 3N, a number of example schematic screenshots, or portions thereof, from a personal computing device are illustratively depicted. The screenshots, or portions thereof, show aspects of example graphical user interfaces (GUIs) that include a presentation of video, ICCs, or supplemental content windows. FIGS. 3A through 3C are described previously in connection with content card presentation generator 270, and show an example creation of an ICC, which is depicted as ICC 335 in FIG. 3D. In the example, as further described in connection with FIGS. 3A through 3C, a user creates ICC 335 shown in FIG. 3D. The ICC 335 is created for an entity panipuri, which is an object depicted in the video 309 and indicated as entity 332 in ICC 335. The ICC 335 also shows that the presentation criterion is an object detection criterion, as indicated by object detection criterion icon 326.

FIG. 3E provides another example aspect of the creation of ICC 335, where ICC 335 is shown over video 309. In this example aspect, ICC 335 is depicted in an editing mode, as indicated by various icons 337 adjacent to ICC 335, and is enabling the creator of ICC 335 (or a subsequent editor of ICC 335) to alter ICC 335, such as by changing the location, size, or orientation of ICC 335 with respect to video 309, changing the presentation criterion, making a copy, deleting, or performing other modifications. For example, in one embodiment the user can modify the location, size, or orientation of ICC 335 by touching the ICC 335 and dragging it, rotating it, or resizing it using their fingers or a stylus on a GUI 301 that comprises a touch-sensitive surface.

Further, in this example aspect involving the creation (or modification) of ICC 335, a visual indicator 333 is shown on video 309 corresponding to the object depicted in the video for which the entity 332 corresponds. Here, visual indicator 333 is presented over a panipuri. In this way, the creator or editor is provided visual indicator 333 to confirm the object with which the entity 332 of the ICC 335 corresponds. Additionally, as ICC 335 has a presentation criterion that is an object detection criterion, visual indicator 333 indicates an object in video 309 that will trigger a presentation of ICC 335 upon its detected appearance in video 309.

Turning to FIGS. 3F and 3G, another example aspect of ICCs is depicted showing a video 349 presented via GUI 341 on a user device 340. GUI 341 comprises a graphical user interface similar to GUI 301 in FIG. 3A, and user device 340 comprises a computing device similar to user device 300 in FIG. 3A. With reference to FIG. 3F, two ICCs are shown being presented over video 349 including ICC 335 and ICC 347. ICC 335 is described in connection with FIGS. 3B through 3E. ICC 347 indicates an entity name 348 for Delhi, a location of the video 349. ICC 347 also indicates that its present criterion is a temporal criterion, as indicated by presentation criterion icon 346. Accordingly, a viewer of video 349 will be presented ICC 347 for a time duration as indicated in the presentation criterion; for example, ICC 347 is presented for the first 10 seconds of video 349. The viewer of video 349 will be presented ICC 335 upon detection of a panipuri, which is the object corresponding to the entity indicated by ICC 335. Upon an interaction with ICC 335 or ICC 347, the viewer will be presented with a supplemental content window displaying supplemental information regarding the entity indicated in the ICC.

With reference to FIG. 3G and continuing reference to FIG. 3F, an example supplemental content window 355 is depicted over video 349. In this example, a viewer has interacted with ICC 335, such as by touching the ICC 335. Supplemental content window 355 includes an entity indication 352 corresponding to the entity 332 of the ICC 335 that was interacted with by the viewer. Supplemental content window 355 also includes supplemental information 356 comprising content regarding the entity, which may be determined as described in connection with supplemental content generator 280 in FIG. 2. In this particular example, supplemental information 356 includes a description of panipuri, the entity indicated by ICC 335. Supplemental content window 355 is presented over video 349, which may continue to play or may pause so long as the viewer is viewing the supplemental information. For example, to dismiss the supplemental content window 355 and resume watching the video without obstruction, the viewer can engage close button 358. In some embodiments, after a particular viewer has interacted with a particular ICC and been presented a supplemental content window, the particular ICC is no longer presented to the viewer during that viewing session. However, in a subsequent viewing of the video, the ICC may again be present to that viewer. In some embodiments, content card data associate with the ICC includes data indicating viewing information regarding the ICC, such as whether it has been presented, whether it has been interacted with, how often it has been viewed or interacted with, the time or date of a viewing or an interaction, or other data indicating viewing information of the ICC.

With reference now to FIGS. 3H, 3I, and 3J, three example ICCs are depicted in FIGS. 3H, 3I, and 3J as ICC 363, ICC 365, and ICC 367 respectively. Example ICCs 363, 365, and 367 each depict various features or functionalities of the ICC, which are specified as card properties associated with the ICC. For example, ICC 363 includes user feedback function 364 enabling a viewer of ICC 363 to provide feedback as to how helpful ICC 363 is at providing contextual information about a video on which it is presented. In some embodiments, where multiple ICCs are available to be presented simultaneously at a particular portion of a video, ICCs having a higher viewer-feedback rating may be prioritized for presentation. For instance, in some implementations, a maximum number of ICCs may be presented at any one time on the video, and ICCs having a higher rating are prioritized for presentation. Similarly, ICC creators who have higher viewer feedback for ICCs they have created may have their ICCs prioritized for presentation over other ICCs.

ICC 365 includes editing functionality, as indicated by editing icon 366. For example, ICC 365 may be edited by other viewers. In some instances, only downstream viewers connected to the editor will see the edited ICC. In other implementations such as where ICCs are hosted on a platform that is accessed by all viewers such that all viewers are viewing the same source video, any subsequent viewer will see the edited version of the ICC. For example, in one implementation, videos are hosted within a company or organization, such as on a corporate share drive. The videos may be viewed in a company feed, internal social media site, or via communications channels or conversations within a communications application. Accordingly, subsequent viewers to the video will be presented with the edited ICCs. In some embodiments, where the video header or metadata include a pointer to an externally stored card data, modifications made to an ICC can be stored with the card data. In this way, any viewers of the ICC will be able to see the edited ICC, even if the corresponding video is shared across different platforms or presented on different platforms.

ICC 367 includes a no-editing indication 368 indicating that ICC 367 is unable to be edited. For example, the creator of ICC 367 may desire that the ICC 367 is not editable and thus set a card property for ICC that editing is not permitted.

With respect to FIGS. 3K and 3L, an example ICC 370 is depicted in FIG. 3K, and a corresponding supplemental content window 385 is depicted in FIG. 3L over a video 389 via GUI 381 on user device 380. ICC 370 includes an indication of entity 372 and an indication of commenting functionality 377. A commenting function enables viewers to provide comments for the ICC 370. For example, a user may desire to comment on their experience or reaction regarding the entity indicated in the ICC 370. As described with editing functionality of ICC 365 in FIG. 3I, in some instances, only downstream viewers connected to a commenter will see a particular comment added to ICC 370—for example, if a commenter adds a comment and then reposts or shares the ICC 370. In other implementations such as where ICCs are hosted on a platform that is accessed by all viewers such that all viewers are viewing the same source video, any subsequent viewer can see comments left by other viewers. For example, in one implementation, videos are hosted within a company or organization, such as on a corporate share drive. The videos may be viewed in a company feed, internal social media site, or via communications channels or conversations within a communications application. Accordingly, subsequent viewers to the video will see comments. In some embodiments, where the video header or metadata include a pointer to an externally stored card data, comments added to an ICC can be stored with the card data. In this way, any viewers of the ICC will be able to see the comments, even if the corresponding video is shared across different platforms or presented on different platforms.

Supplemental content window 385 corresponds to ICC 370 with commenting functionality 377. Supplemental content window 385 includes supplemental information 386 regarding the entity corresponding to ICC 370. For instance, ICC 370 indicates the entity 372, which is panipuri. Thus, supplemental content window 385 provides supplemental information 386 regarding the entity panipuri, as indicated at 382. Supplemental content window also includes viewer comments interface 387. Viewer comments interface 387 comprises a user interface for receiving and presenting comments from viewers.

With reference now to FIGS. 3M and 3N, aspects of another example embodiment of ICCs are illustratively provided. As shown in FIGS. 3M and 3N, a video 399 is presented, via GUI 391, a user device 390. GUI 391 comprises a graphical user interface similar to GUI 301 in FIG. 3A, and user device 390 comprises a computing device similar to user device 300 in FIG. 3A.

With reference to FIG. 3M, video 399 depicts a food blogger video and includes a first object indicator 392 and a second object indicator 394. In this example, the object indicated by object indicator 392 is a honey garlic salmon, and the object indicated by object indicator 394 is a cookbook. In some embodiments, ICC creators may desire to minimize the appearance of the ICCs so that their presentation does not block the underlying video, but still convey to users that an ICC (or contextual information) can be presented. Accordingly, in some embodiments, such as the example depicted in FIGS. 3M and 3N, video 399 in FIG. 3M depicts object indicators for entities that have ICCs. Upon a viewer interacting with an object indicator, the viewer is presented the ICC corresponding to the object. For example, a viewer touching or clicking on the depiction of salmon, indicated via object indicator 392, is presented ICC 395 (FIG. 3N). Similarly, a viewer touching or clicking on the depiction of the cookbook, indicated via object indicator 394, is presented ICC 397 (FIG. 3N).

Continuing the example depicted in FIGS. 3N and 3M, upon interaction with ICC 395, which corresponds to the entity “honey garlic salmon” indicated by object indicator 392 (FIG. 3M), the viewer is presented a supplemental content window with supplemental information that is the recipe for making the honey garlic salmon. In this example, an instruction is provided by supplemental content generator 280 for performing a query operation using the entity “honey garlic salmon” such that a recipe is returned as a query result. In some implementations, the instruction specifies a particular domain for knowledge base 290 to search from to determine a query result, such as a database of recipes by the food blogger. Alternatively, the instruction can specify that the query operation should return a recipe for the entity.

Upon interaction with ICC 397, which corresponds to the cookbook entity indicated by object indicator 394, the viewer is presented a supplemental content window with supplemental information that is about the cookbook. In some instances, the supplemental information includes a link to purchase the cookbook. In this example, similar to the recipe example regarding ICC 395, an instruction is provided by supplemental content generator 280 for performing a query operation using the cookbook entity such that purchasing information is returned as a query result. In some implementations, the instruction specifies a particular domain for knowledge base 290 to search from to determine a query result, such as a database of products for sale. Alternatively, the instruction can specify that the query operation should return purchase information for the entity.

Turning now to FIGS. 4 and 5, aspects of example process flows 400 and 500 are illustratively depicted for some embodiments of the disclosure. Embodiments of process flows 400, 500, and 600 each comprise a method (sometimes referred to herein as method 400 and 500) carried out to implement various example embodiments described herein. Each block or step of process flow 400 and process flow 500, as well as other methods described herein, comprises a computing process performed using any combination of hardware, firmware, and/or software. For instance, various functions are carried out by a processor executing instructions stored in memory, such as memory 612 as described in FIG. 6 and/or as storage 225 as described in FIG. 2. Embodiments of these methods can also be implemented using computer-usable instructions stored on computer storage media. Embodiments of the methods are provided by a stand-alone application, a service or hosted service (stand-alone or in combination with another hosted service), or a plug-in to another product, to name a few. For example, the blocks of process flows 400 and 500 correspond to operations (or steps) to be performed (as opposed to information to be processed or acted on). In some embodiments, these operations are carried out by one or more computer applications or services, which operate on one or more: user devices (such as user device 102a of FIG. 1), servers (such as server 106 of FIG. 1), distributed computing systems (such as described in connection with FIG. 7), or in the cloud. Further and in some embodiments, the functions performed by the blocks of process flows 400 and 500 are carried out by components of system 200, as described in FIG. 2.

With reference to FIG. 4, aspects of example process flow 400 are illustratively provided for presenting an ICC with a video. Example aspects of ICCs are illustrated in FIGS. 3A through 3N. At a block 410, method 400 includes accessing a video. In some embodiments, the video comprises prerecorded video media, a live video feed, a video file, or streaming video media. For example, the video is accessed from video data in a data store, such as video data 240 in storage 225, described in FIG. 2, or the video is accessed from a video source, such as data source 104 (a) of FIG. 1. At a block 420, determining an ICC associated with the video, the ICC including an indication of an entity associated with the video and a presentation criterion for presenting the ICC. Embodiments of block 420 determine an ICC associated with a video based on metadata associated with the video or a header of the video. For example, content card data for the ICC may be stored in the header or metadata, or a pointer may be stored in the header or metadata, the pointer pointing to externally stored content card data. Some embodiments of blocks 410 and 420 are carried out using video player 210, or ICC-reading service 212 (FIG. 2). Additional details regarding embodiments of blocks 410 and 420 are described in connection to FIG. 2, and in particular video player 210 and ICC-reading service 212.

At a block 430, determining a condition corresponding to the presentation criterion for presenting the content card is satisfied. Embodiments of block 430 determine from the video whether a presentation criterion is satisfied, indicating that the ICC should be presented. The presentation criterion is specified in card data for the ICC. Some embodiments of block 430 are carried out by content card presentation generator 270 (FIG. 2). Additional details regarding embodiments of block 430 are described in connection to FIG. 2, and in particular to content card presentation generator 270 and its subcomponents.

At a block 440, based on the condition corresponding to the presentation criterion being satisfied, the ICC is presented. For example, the ICC is presented to a viewer via a GUI on a user device associated with the viewer, such as a mobile device. Embodiments of block 440 determine that the presentation criterion for presenting an ICC is satisfied, which then causes presentation of the ICC. In some embodiments, the ICC is presented with the video, such as in an overlay or layer on top of the video, which continues to play. Some embodiments of block 440 are carried out by content card presentation generator 270 and GUI 220 of FIG. 2. Additional details regarding embodiments of block 440 are described in connection to FIG. 2, and in particular content card presentation generator 270 and GUI 220.

At a block 450, detect a user interaction with the ICC. Embodiments of block 450 detect an interaction with the ICC by a viewer, such as a touch, click, or other engagement with the ICC. Some embodiments of block 450 are carried out by GUI 220 of FIG. 2. Additional details regarding embodiments of block 440 are described in connection to FIG. 2, and in particular GUI 220. At a block 460, several operations are performed in response to detecting the user interaction with the ICC, including at blocks 462 and 464. At block 462, generate supplemental information regarding the entity. Embodiments of block 462 generate supplemental information for the entity indicated by the ICC with which a viewer interacted. For example, the supplemental information is generated by performing a query operation on a knowledge base using the entity and generating the supplemental information from the result of the query operation. At block 464, the supplemental information generated at block 462 is presented via a supplemental content window. For example, the supplemental content window is presented in a manner similar to an ICC by overlaying its presentation on top of a video. Some embodiments of blocks 462 and 464 are carried out by supplemental content generator 280 of FIG. 2. Additional details regarding embodiments of blocks 462 and 464 are described in connection to FIG. 2, and in particular to supplemental content generator 280 and its subcomponents.

With reference to FIG. 5, aspects of example process flow 500 are illustratively provided for creating an ICC for presentation with a video. Example aspects related to the creation of ICCs are illustrated in FIGS. 3A through 3D. At a block 510, method 500 includes accessing a video. In some embodiments, the video comprises prerecorded video media, a live video feed, a video file, or streaming video media. For example, the video is accessed from video data in a data store, such as video data 240 in storage 225, described in FIG. 2, or the video is accessed from a video source, such as data source 104 (a) of FIG. 1. Some embodiments of blocks 510 are carried out using video player 210, or ICC-reading service 212 (FIG. 2). Additional details regarding embodiments of block 510 are described in connection to FIG. 2, and in particular video player 210 and ICC-reading service 212.

At a block 520, an input is received corresponding to the creation of an ICC. Embodiments of block 520 receive an input, such as an input received from an ICC creator, to create an ICC. The input includes an indication of an entity associated with the video. For instance, a user accesses a function on a computer application to create an ICC for the video. An example of a user providing an indication to create an ICC is described in connection with FIGS. 3A through 3C, and in particular UI element 305 in FIG. 3A and field 322 in FIG. 3C. Some embodiments of blocks 520 are carried out using content card creator 250 in FIG. 2. Additional details regarding embodiments of block 520 are described in connection to FIG. 2, and in particular to content card creator 250.

At block 530, determine the entity has a corresponding search result from a search query performed based on the entity. Embodiments of block 530 determine that the entity indicated in the input from block 520 has a corresponding search result. The search result is determined from performing a search query based on the entity. For example, some embodiments include performing a search query using a knowledge base, such as knowledge base 290, wherein the search is performed using the entity indicated from the first input received at block 520. Based on the query operation, the query result is processed to determine that it corresponds to the entity. In some embodiments, the query result or an aspect of the query result is provided to the ICC creator. In this way, the ICC creator is provided an example of the supplemental information that will be presented to viewers who interact with the ICC. The ICC creator may change the particular entity or provide additional information regarding the entity so that the query result is as the ICC creator expects. For example, for the entity “panipuri,” based on the example of the supplemental information provided, if the supplemental information is not as expected, the ICC creator may determine to change the entity to “Panipuri Indian Snack.” Further, in some embodiments, where the query operation provides multiple query results, the ICC creator selects a particular result, or provides similar feedback based on the query result. The ICC creator selection or feedback is used to generate an instruction to accompany the future query operation that will be performed upon an interaction with the ICC in order to generate supplemental content for presentation to the viewer who interacted with the ICC. Some embodiments of block 530 are performed by content card creator 250 and content card presentation generator 270 of FIG. 2. Additional details regarding embodiments of block 530 are described in connection to FIG. 2.

At a block 540, determine a presentation criterion specifying a condition for presenting the ICC. Embodiments of block 540 determine a presentation criterion. In some embodiments, block 540 determines a presentation criterion based on input received from a user who is creating the ICC, such as described in connection with FIG. 3C. In other embodiments, block 540 determines a presentation criterion based on an entity type for the entity provided as input by the user, such as described in connection with content card creator 250 in FIG. 2.

At a block 550, generate the ICC including the indication of the entity associated with the video and the presentation criterion. Embodiments of block 550 include performing operations to generate the ICC, and in particular, performing operations to generate the content card data that represents the ICC. Embodiments of block 550 generate content card data that includes (1) an indication of the entity from the input received at block 520, and (2) the presentation criterion determined at block 540. Some embodiments of blocks 540 and 550 are carried out by content card creator 250 (FIG. 2). Additional details regarding embodiments of blocks 540 and 550 are described in connection to FIG. 2, and in particular to content card creator 250.

At a block 560, store a record indicating an association of the ICC and the video. Embodiments of block 560 store the record in a header of the video or in metadata associated with the video. In some implementations, the record comprises content card data for the ICC. Alternatively, in some implementations, the record comprises a pointer that points to content card data stored externally to the video. For example, the content card data may be stored as content card data 232 in storage 225 of FIG. 2. Some embodiments of block 560 are carried out by video-card data packager 260 (FIG. 2). Additional details regarding embodiments of block 560 are described in connection to FIG. 2, and in particular to video-card data packager 260.

Accordingly, various aspects of technology have been described directed to systems and methods for the creation and presentation of ICCs that can be interacted with by a viewer during video viewing or playback. It is understood that various features, subcombinations, and modifications of the embodiments described herein are of utility and are employed in other embodiments without reference to other features or subcombinations. Moreover, the order and sequences of steps shown in the example methods 400 and 500 are not meant to limit the scope of the present disclosure in any way, and in fact, the steps can occur in a variety of different sequences within embodiments hereof. Such variations and combinations thereof are also contemplated to be within the scope of embodiments of this disclosure.

### OTHER EMBODIMENTS

In some embodiments, a computing system is provided, employing any components of the computerized (or computer, computing, or cloud) system of any of the embodiments described herein. The computing system comprises at least one computer processor, and computer memory having computer-readable instructions embodied thereon, that, when executed by the at least one computer processor, perform operations. The operations comprise accessing a video and determining a content card associated with a video. The content card includes an indication of an entity associated with the video and a presentation criterion for presenting the content card. The operations further comprise determining a condition corresponding to the presentation criterion for presenting the content card is satisfied. The operations further comprise, based on the condition corresponding to the presentation criterion being satisfied, causing presentation of the content card, via a user interface, during a presentation of the video. The operations further comprise detecting, via the user interface, a user interaction with the content card. The operations further comprise, in response to detecting the user interaction: generating, based on the card entity, a content to be provided via a content window; causing presentation, via the user interface, of the content window; and causing the content to be presented via the content window.

Advantageously, these and other embodiments, as described herein improve existing digital video viewing technologies by providing new functionality enabling interactive, content cards, which may be viewer generated in some implementations, and may provide portability across various platforms, in some implementations thereby offering dynamic presentation tied to video content, maintaining viewer engagement, and delivering current and dynamic supplemental information. In particular, these and some other embodiments described herein improve computing applications for viewing digital video by providing functionality enabling a viewer to add a content cards to video, with the card data comprising merely an indication of an entity and a presentation criterion-being lightweight enough to be stored in the video file header or metadata associated with the video. This portability is a notable advantage, as ICC content can remain with the video file, allowing it to be shared and interacted with across various platforms. Further, these embodiments improve computing technology by generating supplemental information to be provided to a viewer at the time of viewer interaction with the ICC. In this way, the ICC technology provides supplemental information that is current and somewhat dynamic, reflecting any changes in search results or knowledge base outputs. Further still, in some instances these embodiments provide functionality to dynamically present ICCs based on the content of the video itself, such as the appearance of an object or the occurrence of an event. Moreover, the ICC technology can maintain viewer engagement by overlaying over the video the ICC or the supplemental information provided when a viewer interacts with an ICC, thereby allowing the viewer to continue watching.

In any combination of the above embodiments of the system, generating the content based on the card entity comprises: generating a query input for a knowledge base; performing a query operation using the knowledge base and the query input; receiving a query result; and providing a representation of the query result as the content.

In any combination of the above embodiments of the system, the knowledge base comprises a language mode, wherein the query input comprises an input prompt for the language model that includes the entity and an instruction to generate a summary explanation regarding the entity, and wherein the query result comprises an output provided by the language model in response to receiving the input prompt.

In any combination of the above embodiments of the system, the content card is caused to be presented over the video, and while the video is presented, by using a layer such that the video is not modified to include presentation of the content card; and wherein the detecting the user interaction with the content card comprises detecting a user engagement with the content card.

In any combination of the above embodiments of the system, the presentation criterion comprises a temporal criterion, an event detection criterion for an event in the video and corresponding to the entity, or an object detection criterion for an object in the video and corresponding to the entity.

In any combination of the above embodiments of the system, the presentation criterion comprises the object detection criterion for the object corresponding to the entity, and wherein the condition is determined to be satisfied based on a detection of the object in the video by using video object detection.

In any combination of the above embodiments of the system, the presentation criterion comprises the object detection criterion for the object corresponding to the entity.

In any combination of the above embodiments of the system, the operations further comprise in response to detecting the user interaction with the content card, causing presentation of a visual indicator on the object in the video and corresponding to the entity.

In any combination of the above embodiments of the system, the operations further comprise subsequent to causing presentation of the content card, determining the condition corresponding to the presentation criterion for presenting the content card is not satisfied; and based on the condition corresponding to the presentation criterion not being satisfied, causing the content card not to be presented.

In any combination of the above embodiments of the system, the content card associated with the video is determined based on metadata or a header of the video, and wherein the video comprises prerecorded video media, a live video feed, a video file, or streaming video media.

In any combination of the above embodiments of the system, the content card associated with the video is generated by: receiving an input corresponding to creation of the content card, the input comprising at least the indication of the entity associated with the video and the presentation criterion for presenting the content card; generating the content card comprising the indication of the entity associated with the video and the presentation criterion; and storing, in the metadata or the header of the video, a record indicating an association of the content card and the video.

In any combination of the above embodiments of the system, the content card further includes a card property, wherein the presentation of the content card is caused to be presented in accordance with the card property, and wherein the card property comprises: a card formatting aspect indicating a size of the card, an orientation of the card, or a location for presenting the card with respect to the location of the video; an attribution aspect comprising a first visual indication of an original creator of the content card; a feedback aspect comprising a first user interface element configured to enable a viewer of the content card to provide feedback regarding the content card; an editing aspect comprising one of a second visual indication that the content card is not editable or a second user interface element configured to enable the viewer of the content card to modify an aspect of the content card; or a comment aspect comprising a third user interface element configured to enable the viewer to input a text-based comment.

In some embodiments, a computer-implemented method is provided. The method comprises accessing a video. The method further comprises receiving a first input corresponding to creation of a content card, the first input including an indication of an entity associated with a video. The method further comprises determining the entity has a corresponding search result from a search query performed based on the entity, the search result including information regarding the entity. The method further comprises determining a presentation criterion specifying a condition for presenting the content card. The method further comprises generating the content card comprising the indication of the entity associated with the video and the presentation criterion. The method further comprises storing, in metadata associated with the video or a header of the video, a record indicating an association of the content card and the video.

Advantageously, these and other embodiments, as described herein improve existing digital video viewing technologies by providing new functionality enabling interactive, content cards, which may be viewer generated in some implementations, and may provide portability across various platforms, in some implementations thereby offering dynamic presentation tied to video content, maintaining viewer engagement, and delivering current and dynamic supplemental information. In particular, these and some other embodiments described herein improve computing applications for viewing digital video by providing functionality enabling a viewer to add a content cards to video, with the card data comprising merely an indication of an entity and a presentation criterion-being lightweight enough to be stored in the video file header or metadata associated with the video. This portability is a notable advantage, as ICC content can remain with the video file, allowing it to be shared and interacted with across various platforms. Further, these embodiments improve computing technology by generating supplemental information to be provided to a viewer at the time of viewer interaction with the ICC. In this way, the ICC technology provides supplemental information that is current and somewhat dynamic, reflecting any changes in search results or knowledge base outputs. Further still, in some instances these embodiments provide functionality to dynamically present ICCs based on the content of the video itself, such as the appearance of an object or the occurrence of an event. Moreover, the ICC technology can maintain viewer engagement by overlaying over the video the ICC or the supplemental information provided when a viewer interacts with an ICC, thereby allowing the viewer to continue watching.

In any combination of the above embodiments of the method, the video comprises prerecorded video media, a live video feed, a video file, or streaming video media.

In any combination of the above embodiments of the method, the entity comprises a person, object, or event depicted in the video or a location associated with the video.

In any combination of the above embodiments of the method, the presentation criterion comprises a temporal criterion, an event detection criterion for an event in the video and corresponding to the entity, or an object detection criterion for an object in the video and corresponding to the entity.

In any combination of the above embodiments of the method, the presentation criterion is determined based on the entity or based on receiving a second input from a user, the second input including the presentation criterion.

In any combination of the above embodiments of the method, the method further comprises programmatically determining the entity corresponds to a person or object depicted in the video, by using video object detection, or that the entity corresponds to a location associated with the video by using location data in metadata associate with the video; providing an indication of the entity based on the determined corresponding person, object, or location; receiving from a user, confirmation of the entity; and associating with the entity the person or object depicted in the video or the location associated with the video.

In any combination of the above embodiments of the method, the indication of the entity included in the first input comprises an object.

In any combination of the above embodiments of the method, the method further comprises programmatically determining the object is depicted in the video by using video object detection; associating the detected object in the video with the entity; and wherein the presentation criterion is determined to be a detection of the object in the video.

In any combination of the above embodiments of the method, the method further comprises receiving a second input comprising a card property associated with the content card. The card property comprises: a card formatting aspect indicating a size of the card, an orientation of the card, or a location for presenting the card with respect to the location of the video; an attribution aspect comprising a first visual indication of an original creator of the content card; a feedback aspect comprising a first user interface element configured to enable a viewer of the content card to provide feedback regarding the content card; an editing aspect comprising one of a second visual indication that the content card is not editable or a second user interface element configured to enable the viewer of the content card to modify an aspect of the content card; or a comment aspect comprising a third user interface element configured to enable the viewer to input a text-based comment. The content card is generated to further comprise the card property.

In some embodiments, one or more computer storage media having computer-executable instructions embodied thereon that, when executed by at least one computer processor, cause computing operations to be performed. The operations comprise accessing or receiving a video. The operations further comprise determining a content card associated with a video, the content card including an indication of an entity associated with the video and a presentation criterion for presenting the content card. The operations further comprise determining a condition corresponding to the presentation criterion for presenting the content card is satisfied. The operations further comprise, based on the condition corresponding to the presentation criterion being satisfied, causing presentation of the content card over a presentation of the video by using a layer such that the video is not modified to include the presentation of the content card. The operations further comprise detecting user interaction with the content card by detecting, via a user interface, a user engagement with the content card. The operations further comprise, in response to detecting the user interaction: causing presentation, via the user interface, of a content window; generating, based on the card entity, the content to be provided via the content window; and causing the content to be presented via the content window.

Advantageously, these and other embodiments, as described herein improve existing digital video viewing technologies by providing new functionality enabling interactive, content cards, which may be viewer generated in some implementations, and may provide portability across various platforms, in some implementations thereby offering dynamic presentation tied to video content, maintaining viewer engagement, and delivering current and dynamic supplemental information. In particular, these and some other embodiments described herein improve computing applications for viewing digital video by providing functionality enabling a viewer to add a content cards to video, with the card data comprising merely an indication of an entity and a presentation criterion-being lightweight enough to be stored in the video file header or metadata associated with the video. This portability is a notable advantage, as ICC content can remain with the video file, allowing it to be shared and interacted with across various platforms. Further, these embodiments improve computing technology by generating supplemental information to be provided to a viewer at the time of viewer interaction with the ICC. In this way, the ICC technology provides supplemental information that is current and somewhat dynamic, reflecting any changes in search results or knowledge base outputs. Further still, in some instances these embodiments provide functionality to dynamically present ICCs based on the content of the video itself, such as the appearance of an object or the occurrence of an event. Moreover, the ICC technology can maintain viewer engagement by overlaying over the video the ICC or the supplemental information provided when a viewer interacts with an ICC, thereby allowing the viewer to continue watching.

In any combination of the above embodiments, generating the content based on the card entity comprises: generating a query input for a knowledge base; performing a query operation using the knowledge base and the query input; receiving a query result; and providing a representation of the query result as the generated content.

In any combination of the above embodiments, the presentation criterion comprises an object detection criterion for an object in the video and corresponding to the entity, and wherein the condition is determined to be satisfied based on a detection of the object in the video by using video object detection.

In any combination of the above embodiments, the content card associated with the video is determined based on metadata associated with the video or a header of the video, and wherein the video comprises prerecorded video media, a live video feed, a video file, or streaming video media.

### Example Computing Environments

Having described various implementations, several example computing environments suitable for implementing embodiments of the disclosure are now described, including an example computing device and an example distributed computing environment in FIGS. 6 and 7, respectively. With reference to FIG. 6, an example computing device is provided and referred to generally as computing device 600. The computing device 600 is but one example of a suitable computing environment and is not intended to suggest any limitation as to the scope of use or functionality of embodiments of the disclosure, and nor should the computing device 600 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure are practiced in a variety of system configurations, including mobile devices, consumer electronics, general-purpose computers, more specialty computing devices, or the like. Embodiments of the disclosure can also be practiced in distributed computing environments where tasks are performed by remote-processing devices that are linked through a communications network. In a distributed computing environment, program modules may be located in both local and remote computer storage media including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher-level software. Accordingly, in some embodiments, computer-executable instructions include any software, including low-level software written in machine code, higher-level software such as application software, and any combination thereof. In this regard, the system components can manage resources and provide services for system functionality. Any other variations and combinations thereof are contemplated with the embodiments of the present disclosure.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. In one example, bus 610 represents one or more buses (such as an address bus, data bus, or combination thereof). Although the various blocks of FIG. 6 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 6 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media comprises computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 612 includes computer storage media in the form of volatile and/or non-volatile memory. In one example, the memory is removable, non-removable, or a combination thereof. Hardware devices include, for example, solid-state memory, hard drives, and optical-disc drives. Computing device 600 includes one or more processors 614 that read data from various entities such as memory 612 or I/O components 620. As used herein and in one example, the term processor or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor are performed by more than one processor.

Presentation component(s) 616 presents data indications to a user or other device. Presentation components include, for example, a display device, speaker, printing component, vibrating component, and the like.

The I/O ports 618 allow computing device 600 to be logically coupled to other devices, including I/O components 620, some of which are built-in. Illustrative components include a microphone, joystick, game pad, satellite dish, scanner, printer, or a wireless device. The I/O components 620 can provide a natural user interface (NUI) that processes air gestures, voice, or other physiological inputs generated by a user. In some instances, inputs are transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. In one example, the computing device 600 is equipped with depth cameras, such as stereoscopic camera systems, infrared camera systems, red-green-blue (RGB) camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 include one or more radio(s) 624 (or similar wireless communication components). The radio transmits and receives radio or wireless communications. Example computing device 600 is a wireless terminal adapted to receive communications and media over various wireless networks. Computing device 600 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. In various embodiments, references to “short” and “long” types of connections do not refer to the spatial relation between two devices. Instead, in general references to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of Code-Division Multiple Access (CDMA), General Packet Radio Service (GPRS), Global System for Mobile Communication (GSM), Time-Division Multiple Access (TDMA), and 802.16 protocols.

Referring now to FIG. 7, an example distributed computing system 700 is illustratively provided, in which implementations of the present disclosure can be employed. In particular, FIG. 7 shows a high-level architecture of an example cloud computing platform 710 that can host a technical solution environment, or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing system 700 that include cloud computing platform 710, rack 720, and node 730 (for example, computing devices, processing units, or blades) in rack 720. The technical solution environment can be implemented with cloud computing platform 710, which runs cloud services across different data centers and geographic regions. Cloud computing platform 710 can implement the fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. In one example, the cloud computing platform 710 is a public cloud, a private cloud, or a dedicated cloud.

Node 730 can be provisioned with host 750 (for example, operating system or runtime environment) running a defined software stack on node 730. Node 730 can also be configured to perform specialized functionality (for example, computer nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms “service application,” “application,” or “service” are used interchangeably with regards to FIG. 7, and broadly refer to any software, or portions of software, that run on top of, or access storage and computing device locations within, a datacenter.

When more than one separate service application is being supported by nodes 730, certain nodes 730 are partitioned into virtual machines (for example, virtual machine 752 and virtual machine 754). Physical machines can also concurrently run separate service applications. The virtual machines or physical machines can be configured as individualized computing environments that are supported by resources 760 (for example, hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 780 is linked to a service application in cloud computing platform 710. Client device 780 may be any type of computing device, such as user device 102n described with reference to FIG. 1, and the client device 780 can be configured to issue commands to cloud computing platform 710. In embodiments, client device 780 communicates with service applications through a virtual Internet Protocol (IP) and load balancer or other means that direct communication requests to designated endpoints in cloud computing platform 710. Certain components of cloud computing platform 710 communicate with each other over a network (not shown), which includes, without limitation, one or more local area networks (LANs) and/or wide area networks (WANs).

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present disclosure are described with reference to a computing device or a distributed computing environment; however the computing device and distributed computing environment depicted herein are non-limiting examples. Moreover, the terms computer system and computing system may be used interchangeably herein, such that a computer system is not limited to a single computing device, and nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computer system, comprising:
at least one processor; and
computer memory having computer-readable instructions embodied thereon, that, when executed by the at least one processor, perform operations comprising:
determining a content card associated with a video, the content card including an indication of an entity associated with the video and a presentation criterion for presenting the content card;
determining a condition corresponding to the presentation criterion for presenting the content card is satisfied;
based on the condition corresponding to the presentation criterion being satisfied, causing presentation of the content card, via a user interface, during a presentation of the video;
detecting, via the user interface, a user interaction with the content card;
in response to detecting the user interaction:
based on the card entity, generating, by accessing a knowledge base, a content to be provided via a content window;
causing presentation, via the user interface, of the content window; and
causing the content to be presented via the content window.

2. The system of claim 1, wherein generating the content based on the card entity comprises:
generating a query input for the knowledge base;
performing a query operation using the knowledge base and the query input;
receiving a query result; and
providing a representation of the query result as the content.

3. The system of claim 2, wherein the knowledge base comprises a language mode, wherein the query input comprises an input prompt for the language model that includes the entity and an instruction to generate a summary explanation regarding the entity, and wherein the query result comprises an output provided by the language model in response to receiving the input prompt.

4. The system of claim 1, wherein the content card is caused to be presented over the video, and while the video is presented, by using a layer such that the video is not modified to include presentation of the content card; and wherein the detecting the user interaction with the content card comprises detecting a user engagement with the content card.

5. The system of claim 1, wherein the presentation criterion comprises a temporal criterion, an event detection criterion for an event in the video and corresponding to the entity, or an object detection criterion for an object in the video and corresponding to the entity.

6. The system of claim 5, wherein the presentation criterion comprises the object detection criterion for the object corresponding to the entity, and wherein the condition is determined to be satisfied based on a detection of the object in the video by using video object detection.

7. The system of claim 5:
wherein the presentation criterion comprises the object detection criterion for the object corresponding to the entity; and
further comprising, in response to detecting the user interaction with the content card, causing presentation of a visual indicator on the object in the video and corresponding to the entity.

8. The system of claim 1, further comprising:
subsequent to causing presentation of the content card, determining the condition corresponding to the presentation criterion for presenting the content card is not satisfied; and
based on the condition corresponding to the presentation criterion not being satisfied, causing the content card not to be presented.

9. The system of claim 1, wherein the content card associated with the video is determined based on metadata or a header of the video, and wherein the video comprises prerecorded video media, a live video feed, a video file, or streaming video media.

10. The system of claim 9, wherein the content card associated with the video is generated by:
receiving an input corresponding to creation of the content card, the input comprising at least the indication of the entity associated with the video and the presentation criterion for presenting the content card;
generating the content card comprising the indication of the entity associated with the video and the presentation criterion; and
storing, in the metadata or the header of the video, a record indicating an association of the content card and the video.

11. The system of claim 1, wherein the content card further includes a card property, wherein the presentation of the content card is caused to be presented in accordance with the card property, and wherein the card property comprises:
a card formatting aspect indicating a size of the card, an orientation of the card, or a location for presenting the card with respect to the location of the video;
an attribution aspect comprising a first visual indication of an original creator of the content card;
a feedback aspect comprising a first user interface element configured to enable a viewer of the content card to provide feedback regarding the content card;
an editing aspect comprising one of a second visual indication that the content card is not editable or a second user interface element configured to enable the viewer of the content card to modify an aspect of the content card; or
a comment aspect comprising a third user interface element configured to enable the viewer to input a text-based comment.

12. A computer-implemented method, comprising:
receiving a first input corresponding to creation of a content card, the first input including an indication of an entity associated with a video;
determining the entity has a corresponding search result from a search query performed based on the entity, the search result including information regarding the entity;
determining a presentation criterion specifying a condition for presenting the content card;
generating the content card comprising the indication of the entity associated with the video and the presentation criterion; and
storing, in metadata associated with the video or a header of the video, a record indicating an association of the content card and the video.

13. The computer-implemented method of claim 12:
wherein the video comprises prerecorded video media, a live video feed, a video file, or streaming video media;
wherein the entity comprises a person, object, or event depicted in the video or a location associated with the video;
wherein the presentation criterion comprises a temporal criterion, an event detection criterion for an event in the video and corresponding to the entity, or an object detection criterion for an object in the video and corresponding to the entity; and
wherein the presentation criterion is determined based on the entity or based on receiving a second input from a user, the second input including the presentation criterion.

14. The computer-implemented method of claim 12 further comprising:
programmatically determining the entity corresponds to a person or object depicted in the video, by using video object detection, or that the entity corresponds to a location associated with the video by using location data in metadata associate with the video;
providing an indication of the entity based on the determined corresponding person, object, or location;
receiving from a user, confirmation of the entity; and
associating with the entity the person or object depicted in the video or the location associated with the video.

15. The computer-implemented method of claim 12, wherein the indication of the entity included in the first input comprises an object, and further comprising:
programmatically determining the object is depicted in the video by using video object detection;
associating the detected object in the video with the entity; and
wherein the presentation criterion is determined to be a detection of the object in the video.

16. The computer-implemented method of claim 12, further comprising:
receiving a second input comprising a card property associated with the content card, the card property comprising:
a card formatting aspect indicating a size of the card, an orientation of the card, or a location for presenting the card with respect to the location of the video;
an attribution aspect comprising a first visual indication of an original creator of the content card;
a feedback aspect comprising a first user interface element configured to enable a viewer of the content card to provide feedback regarding the content card;
an editing aspect comprising one of a second visual indication that the content card is not editable or a second user interface element configured to enable the viewer of the content card to modify an aspect of the content card; or
a comment aspect comprising a third user interface element configured to enable the viewer to input a text-based comment; and wherein the content card is generated to further comprise the card property.

17. Computer storage media having computer-executable instructions embodied thereon that, when executed, by one or more processors, cause the one or more processors to perform operations comprising:
determining a content card associated with a video, the content card including an indication of an entity associated with the video and a presentation criterion for presenting the content card;
determining a condition corresponding to the presentation criterion for presenting the content card is satisfied;
based on the condition corresponding to the presentation criterion being satisfied, causing presentation of the content card over a presentation of the video by using a layer such that the video is not modified to include the presentation of the content card;
detecting user interaction with the content card by detecting, via a user interface, a user engagement with the content card;
in response to detecting the user interaction:
causing presentation, via the user interface, of a content window;
based on the card entity, generating, by accessing a knowledge base, the content to be provided via the content window; and
causing the content to be presented via the content window.

18. The computer storage media of claim 17, wherein generating the content based on the card entity comprises:
generating a query input for the knowledge base;
performing a query operation using the knowledge base and the query input;
receiving a query result; and
providing a representation of the query result as the generated content.

19. The computer storage media of claim 17, wherein the presentation criterion comprises an object detection criterion for an object in the video and corresponding to the entity, and wherein the condition is determined to be satisfied based on a detection of the object in the video by using video object detection.

20. The computer storage media of claim 17, wherein the content card associated with the video is determined based on metadata associated with the video or a header of the video, and wherein the video comprises prerecorded video media, a live video feed, a video file, or streaming video media.
